(19) United States
(12) Patent Application Publication
(10) Pub. No.: US 2021/0324667 A1
(43) Pub. Date: Oct. 21, 2021

(54) LOCK SYSTEM FOR DOOR

(71) Applicant: Maglock, LLC, Pensacola, FL (US)

(72) Inventors: Michael Alan Grillo, Pensacola, FL (US); Dale McCarthy, Pensacola, FL (US)

(21) Appl. No.: 17/234,294

(22) Filed: Apr. 19, 2021

Related U.S. Application Data
(60) Provisional application No. 63/013,298, filed on Apr. 21, 2020.

(51) Int. Cl. E05C 9/04; E05C 9/00; E05C 9/18; E05C 9/22

(52) U.S. Cl. CPC E05C 9/041; E05C 9/22; E05C 9/1808; E05C 9/008

(57) ABSTRACT

In one or more embodiment, a lock system for a door is presented. The system includes an interior assembly, an exterior assembly, fasteners, and end brackets. The interior assembly is configured for attachment to an interior side of the door and the exterior assembly is configured for attachment to an exterior side of the door with fasteners connecting the exterior assembly to the interior assembly. The interior assembly includes a mechanical assembly configured to extend the first and second locking bolts outward from the ends of the interior assembly in opposing directions to a locked position in response to a center member being moved from the first position to the second position. The mechanical assembly is configured to retract the first and second locking bolts inward into the interior assembly to an unlocked position in response to the center member being moved from the second position to the first position.

### CROSS REFERENCE TO RELATED APPLICATIONS

This application claims priority to U.S. Provisional Application No. 63/013,298 filed Apr. 21, 2020 and titled LOCK SYSTEM FOR DOOR, which is hereby incorporated herein fully by reference in its entirety.

### FIELD OF THE DISCLOSURE

This disclosure relates to security devices and more particularly to devices for securing and locking a door to prevent entry.

### OVERVIEW OF THE DISCLOSURE

Conventional door locks or deadbolts are not always sufficient to secure a locked door to prevent unauthorized or unintended opening of the door. Oftentimes locked doors may also be forced open by applying sufficient force to break the door, the lock, and/or door jam.

Such forces may occur in severe weather events (e.g., hurricanes), for example, due to high wind pressures and/or impact from windborne debris. If a door is breached in a high wind event, wind forces or pressures inside a building may dramatically increase and result in significantly more damage to the contents and/or structure of a building. High wind events may exert both positive and negative pressures on doors of a building. When strength of the door, lock, jamb and/or frame is inadequate the door may be damaged (e.g., from delamination), be forced open, or be entirely torn from its mounting. Failures from negative pressure (i.e., suction) are more common but positive pressure failures can occur as well.

Intruders may also gain unauthorized entry through a locked door by applying sufficient force to break the lock and/or door jam. Additionally, many conventional door locks or deadbolts utilize a bolt that does not penetrate deeply into a door jamb when locked. Oftentimes, intruders may gain entry through locked doors by using crowbars, jacks, and the like to expand the door jamb outward until the bolt of the door lock no longer engages the jam. Sometime, intruders may gain entry using bump keys or other lock picking techniques to unlock doors. However, it can be difficult to adequately secure a door against unauthorized or unintended entry without inhibiting authorized access. For instance, many buildings may be subject to policies, rules, regulations, or municipal codes, which may require unimpeded egress at all times to allow occupants to leave in case of emergency. In such situation, an occupant needs to be able to easily and quickly unlock a secured door. Conversely, there is also a need for occupants to easily and quickly secure a door. For example, in an active shooter scenario, there is a need for occupants to be able to quickly and easily secure entryways.

Thus it is a primary object of the disclosure to provide a door lock system that can adequately secure a door to inhibit unauthorized and/or unintended opening.

Another object of the disclosure is to provide a door lock system that is easy to use.

Yet another object of the disclosure is to provide a door lock system that can quickly and easily be unlocked by an occupant

Another object of the disclosure is to provide a door lock system that can quickly and easily be locked by an occupant.

Yet another object of the disclosure is to provide a door lock system that is locked and unlocked via simple lateral movement of a member.

Another object of the disclosure is to provide a door lock system inhibits delamination of the door.

Yet another object of the disclosure is to provide a door lock system that provides reinforcement of the door.

Another object of the disclosure is to provide a door lock system that has a small profile and has an aesthetically pleasing appearance

Yet another object of the disclosure is to provide a door lock system that is easy to install. Another object of the disclosure is to provide a door lock system that is relatively inexpensive or affordable.

Yet another object of the disclosure is to provide a door lock system that has a minimum number of parts.

Another object of the disclosure is to provide a door lock system that is simple in design. Yet another object of the disclosure is to provide a door lock system that is not susceptible to lock picking or bump keys.

These and other objects, features, or advantages of the present disclosure will become apparent from the specification, claims and drawings.

### SUMMARY OF THE DISCLOSURE

In one or more embodiment, a lock system for a door is presented. The system includes an interior assembly, an exterior assembly, fasteners, and end brackets. The interior assembly is configured for attachment to an interior side of the door. The interior assembly has an elongated shape extending a length between opposing ends. The exterior assembly is configured for attachment to an exterior side of the door. The exterior assembly has an elongated shape extending a length between opposing ends. The fastener is configured to attach the base of the interior assembly to the exterior assembly through one or more holes in the door.

In one or more embodiments, the interior assembly includes first and second locking bolts. The interior assembly includes a center member. The center member is configured for side to side movement along the length of the interior assembly between a first position and a second position. The interior assembly includes a mechanical assembly configured to extend the first and second locking bolts outward from the ends of the interior assembly in opposing directions to a locked position in response to the center member being moved from the first position to the second position. The first and second end brackets are each configured and arranged to receive an end of one of the first and second locking bolts in the locked position. The mechanical assembly is further configured to retract the first and second locking bolts inward into the interior assembly to an unlocked position in response to the center member being moved from the second position to the first position.

In one or more embodiments, the fastener is configured and arranged, when tightened, to compress the door between the interior assembly and the exterior assembly. In one or more embodiments, the exterior assembly includes a base having a front surface and a rear surface. The base has an elongated shape extending between a top edge, bottom edge, and opposing side edges. The exterior assembly also includes a main body having an elongated shape extending between opposing sides. The main body has a front, a rear, a top and a bottom. In one or more embodiments, the main body includes a plurality of holes extending through the rear of the main body. The main body also includes a recess extending along the length of the main body. A nut is positioned in the recess. The recess is configured to prevent rotation of a nut. A bolt is inserted through one of the plurality of holes and threaded through the nut.

In one or more embodiments, the interior assembly includes a main body configured for attachment to the base of interior assembly. The mechanical assembly of interior assembly includes an operable connection between the first locking bolt and the center member. The mechanical assembly also includes a rack and pinion assembly operably connected to the center member. The rack and pinion assembly is operably connected to the second locking bolt. In response to the center member being moved in a first direction, the rack and pinion assembly moves the second locking bolt in a second direction opposite from the first direction. The operable connection between the first locking bolt and the center member configured to move the first locking bolt in the first direction in response to the center member being moved in the first direction.

In one or more embodiments, the rack and pinion assembly includes a pinion gear, a first rack, and a second rack. The pinion gear is operably attached to the main body in a fixed axis of rotation. The first rack is operably attached to the center member. The second rack is operably attached to the second locking bolt. The first and second racks are operably connected to the pinion gear in a configuration that movement of the first rack in the first direction causes the pinion gear to move the second rack in the opposite second direction.

In one or more embodiments, the main body includes one or more guide tracks. The first and second racks include slide features configured to engage the one or more guide tracks and facilitate movement of the first and second racks along the one or more guide tracks in the first and second directions. In one or more embodiments, the center member includes slide features configured to engage the one or more guide tracks and facilitate movement of the center member in the first and second directions.

In one or more embodiments, the center member includes a latch assembly. The latch assembly includes a button. The latch assembly is configured to latch the center member in place in response to the center member being moved to the second position. The latch assembly is configured to unlatch in response to the button being pressed.

In some embodiments, the latch assembly is configured to latch the center member in place in response to the center member being moved to the first position. The latch assembly is configured to unlatch in response to the button being pressed. In one or more embodiments, each end bracket has a cylindrical shaped hole extending through the end bracket between opposing sides of the end bracket. The end bracket includes a rear bracket member and a front bracket member. The cylindrical shaped hole is positioned between the rear bracket member and the front bracket member. The end bracket includes a collar positioned in the cylindrical shaped hole.

In one or more embodiments, the collar has a cylindrical shape extending between opposing ends. The collar includes a first flange extending around the a first one of the opposing ends. The collar includes a second flange extending around the a second one of the opposing ends. In one or more embodiments, the collar has an opening configured to receive one of the locking bolts when extended to the locked position. In some embodiments, the opening is offset from a center axis of the collar. In some embodiments, the collar is a non-metallic material.

### BRIEF DESCRIPTION OF THE DRAWINGS

FIG. 1 shows an exploded side view of a door lock system, in accordance with one or more arrangements of the present disclosure; the view showing the door lock system installed on a door.

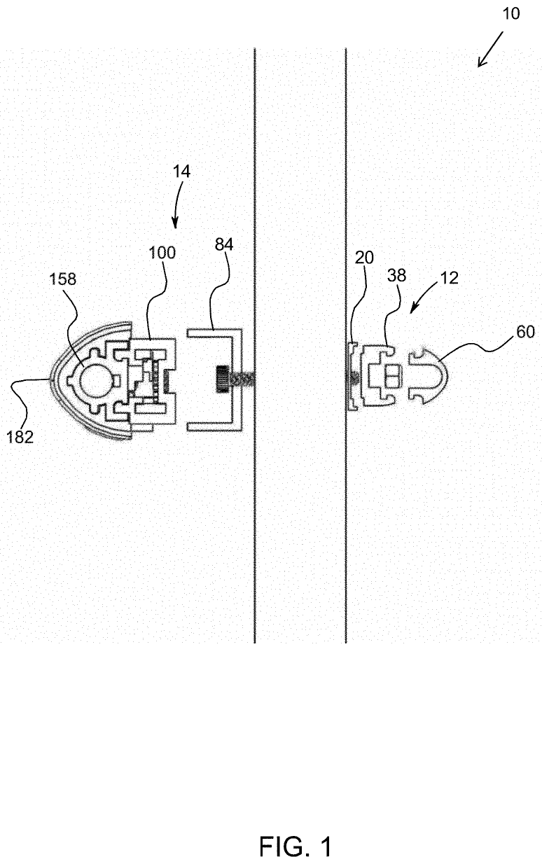

FIG. 2 shows an inside view of a door lock system, in accordance with one or more arrangements of the present disclosure; the view showing locking bolts extended outward to connect with end brackets; the view showing the door lock system installed on a door.

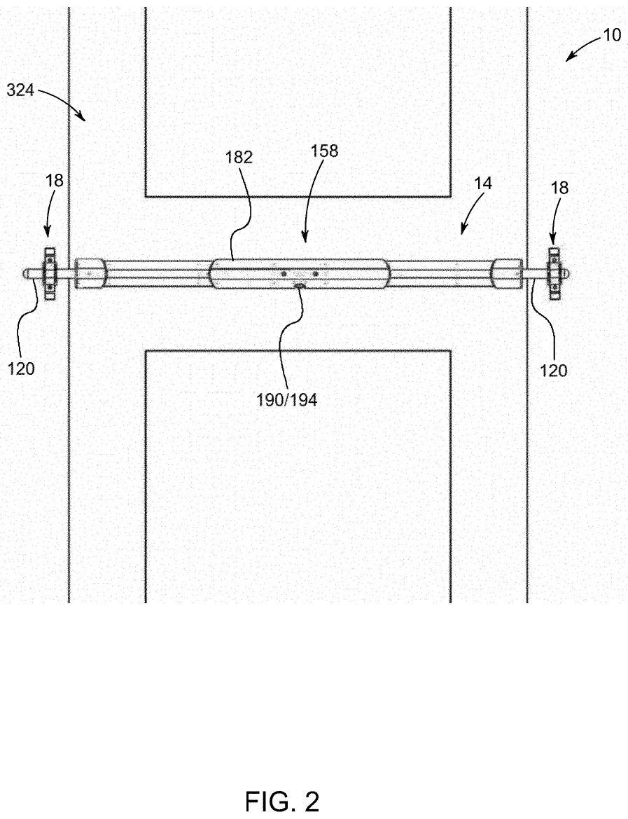

FIG. 3 shows an inside view of a door lock system, in accordance with one or more arrangements of the present disclosure; the view showing locking bolts retracted.

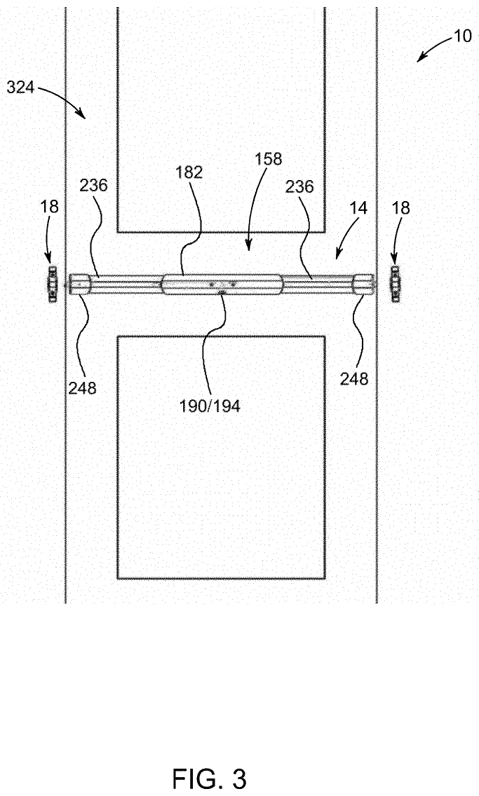

FIG. 4 shows an outside view of a door lock system, in accordance with one or more arrangements of the present disclosure; the view showing locking bolts extended outward to connect with end brackets; the view showing the door lock system installed on a door.

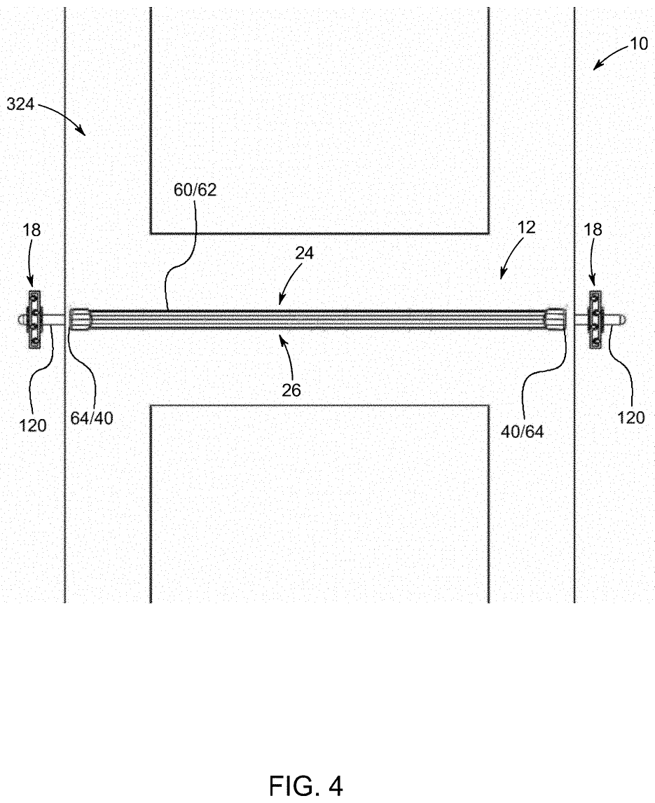

FIG. 5 shows an outside view of a door lock system, in accordance with one or more arrangements of the present disclosure; the view showing locking bolts retracted; the view showing the door lock system installed on a door.

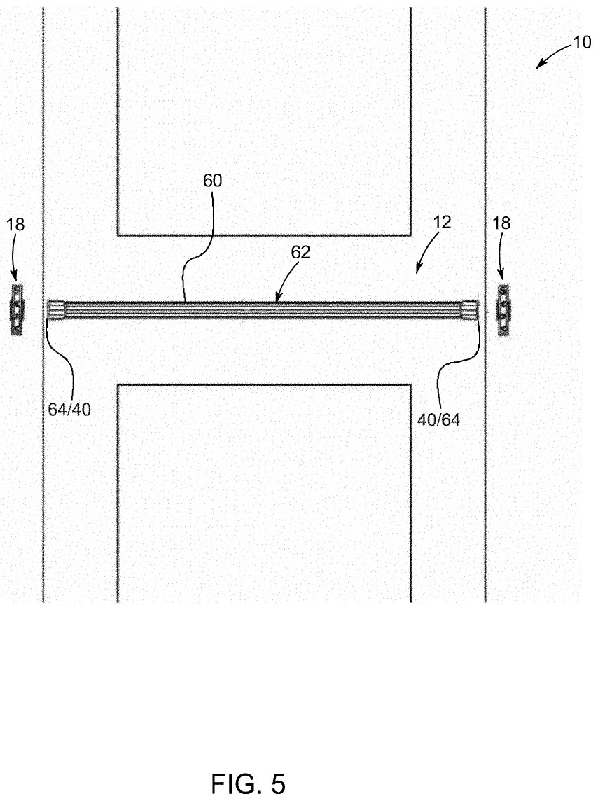

FIG. 6 shows a side view of a door lock system, in accordance with one or more arrangements of the present disclosure; the view showing the door lock system installed on a door.

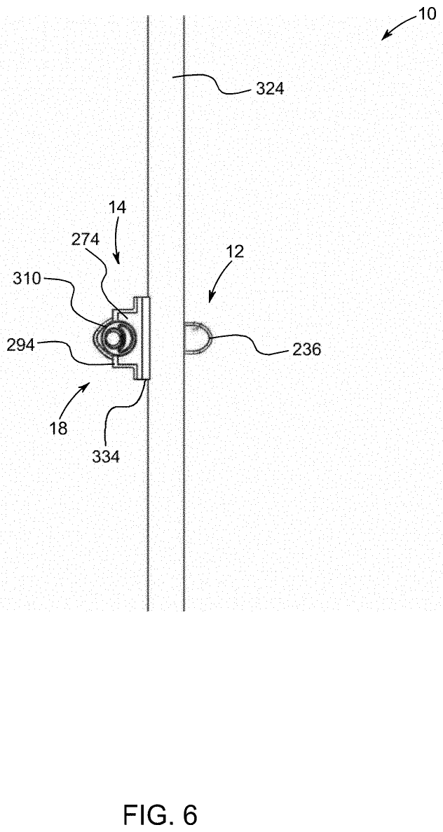

FIG. 7 shows an upper left inside perspective view of a door lock system, in accordance with one or more arrangements of the present disclosure; the view showing locking bolts extended outward to connect with end brackets; the view showing the door lock system installed on a door.

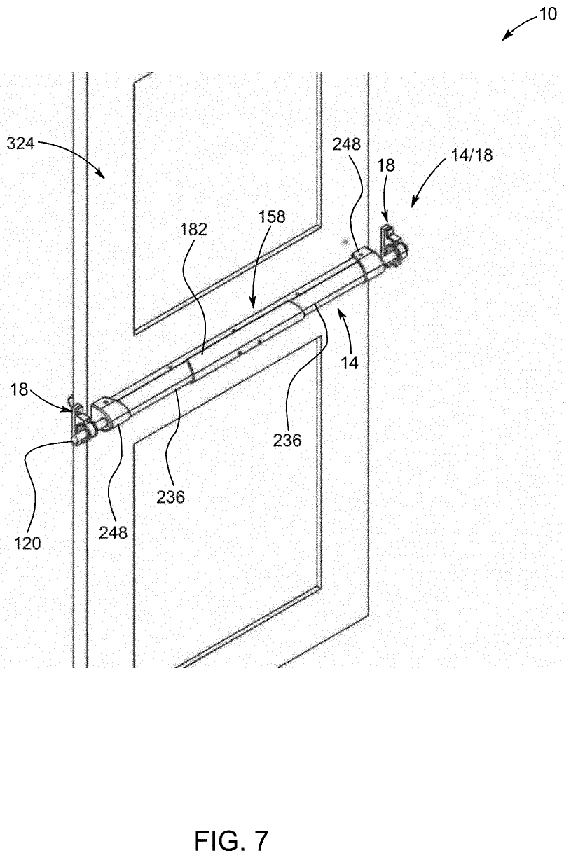

FIG. 8 shows an upper left outside perspective view of a door lock system, in accordance with one or more arrangements of the present disclosure; the view showing internal assembly, external assembly, and end brackets of the door lock system with door omitted.

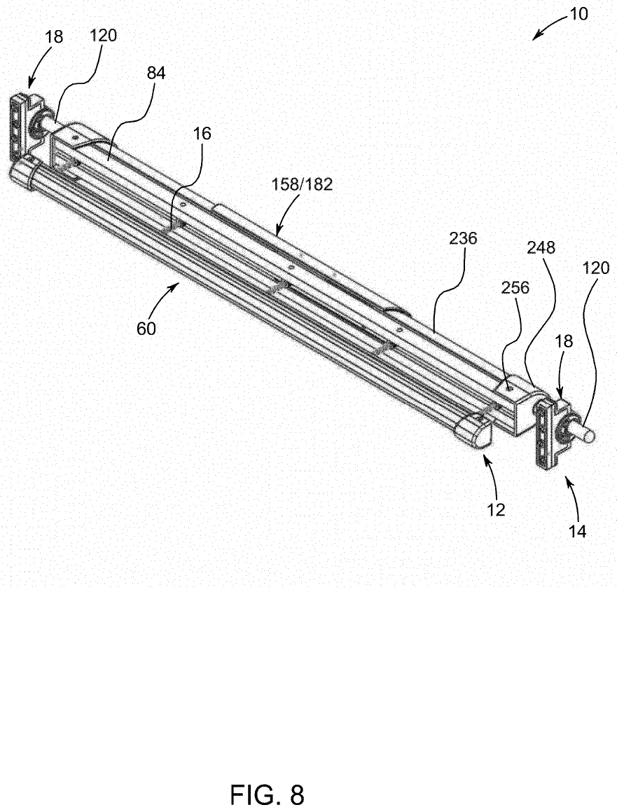

FIG. 9 shows an upper right inside perspective view of a door lock system, in accordance with one or more arrangements of the present disclosure; the view showing locking bolts extended outward to connect with end brackets; the view showing the door lock system installed on a door.

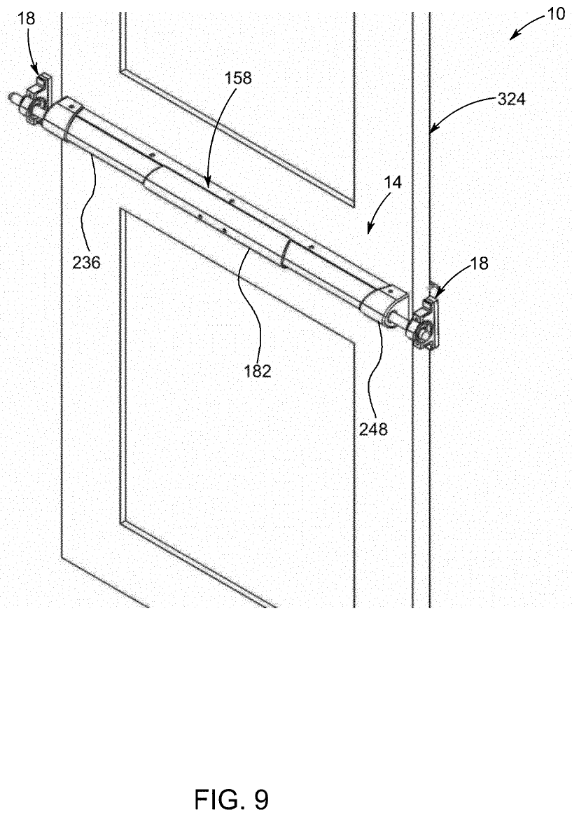

FIG. 10 shows an upper right inside perspective view of a door lock system, in accordance with one or more arrangements of the present disclosure; the view showing locking bolts extended outward to connect with end brackets; the view showing the door lock system installed on a door.

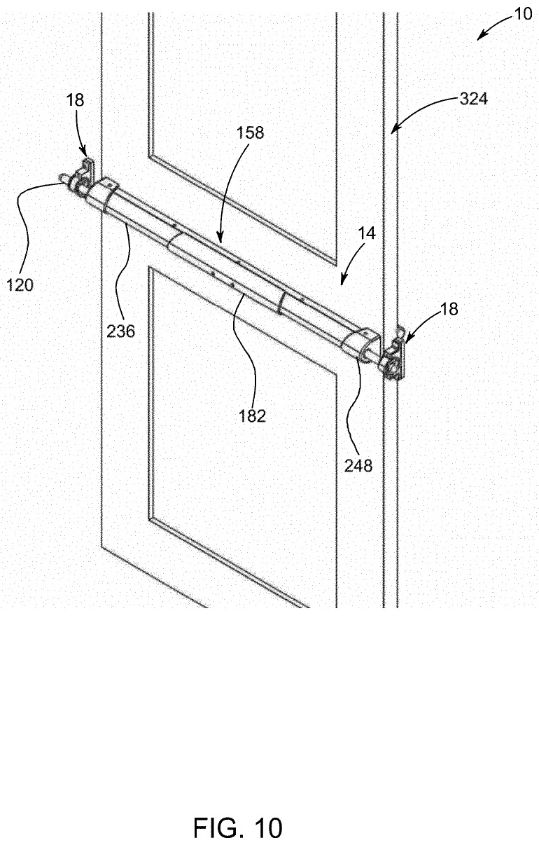

FIG. 11 shows an upper left inside perspective view of a door lock system, in accordance with one or more arrangements of the present disclosure; the view showing internal assembly, external assembly, and end brackets of the door lock system with door omitted.

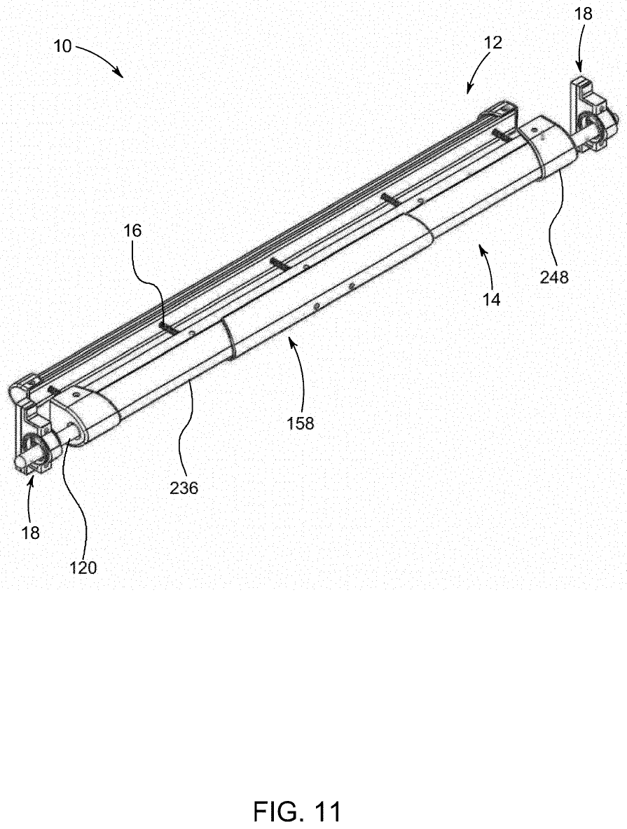

FIG. 12 shows an upper right outside perspective view of a door lock system, in accordance with one or more arrangements of the present disclosure; the view showing locking bolts extended outward to connect with end brackets; the view showing the door lock system installed on a door.

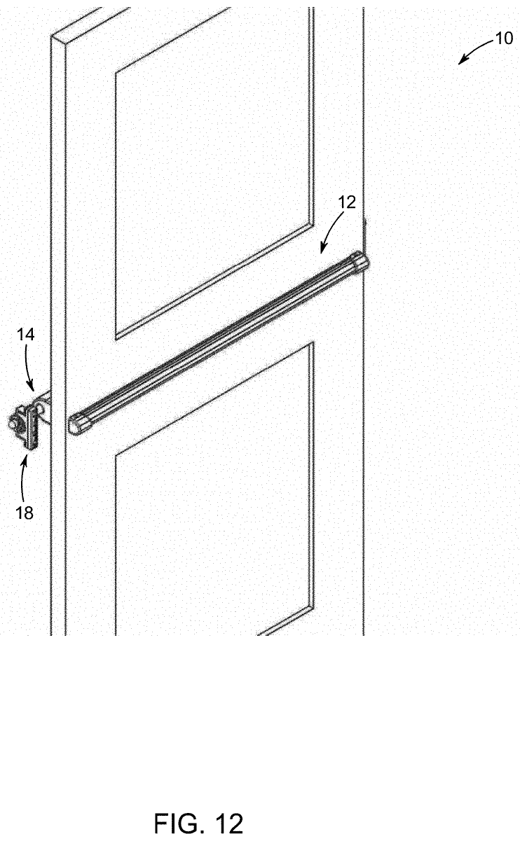

FIG. 13 shows an upper right outside perspective view of a door lock system, in accordance with one or more arrangements of the present disclosure; the view showing internal assembly, external assembly, and end brackets of the door lock system with door omitted.

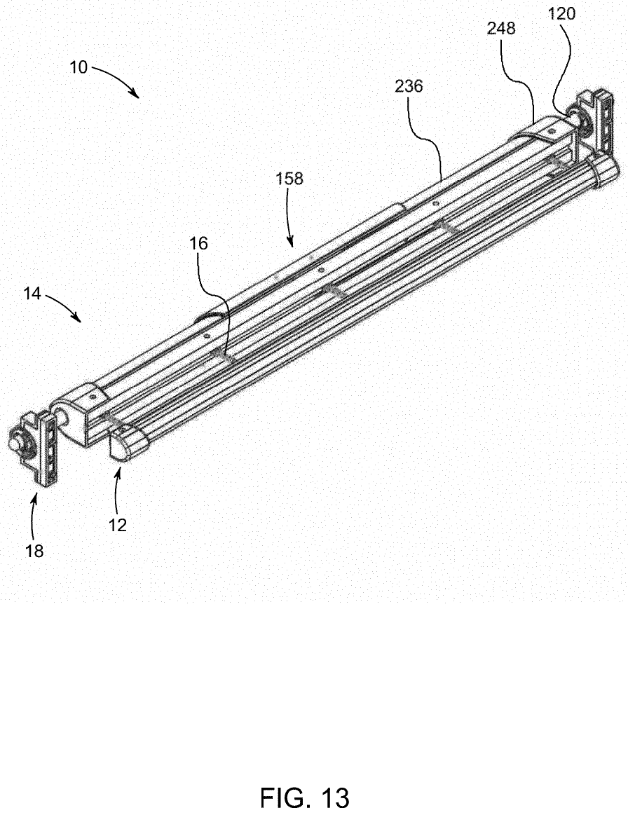

FIG. 14 shows an upper left outside perspective view of a door lock system, in accordance with one or more arrangements of the present disclosure; the view showing internal assembly, external assembly, and end brackets of the door lock system with door omitted.

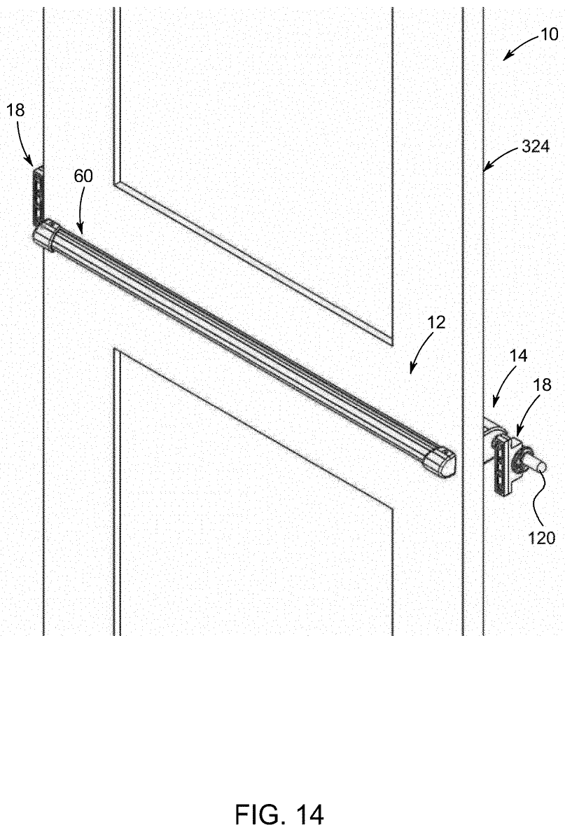

FIG. 15 shows an upper right inside perspective view of a door lock system, in accordance with one or more arrangements of the present disclosure; the view showing internal assembly, external assembly, and end brackets of the door lock system with door omitted.

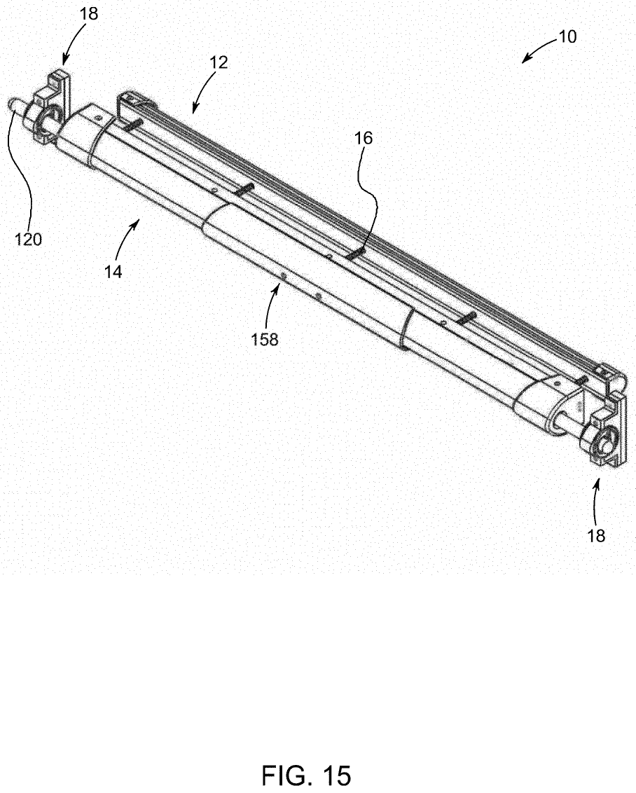

FIG. 16 shows a front view of a mechanical assembly of an internal assembly of a door lock system, in accordance with one or more arrangements of the present disclosure.

FIG. 17 shows a lower front right perspective view of a mechanical assembly of an internal assembly of a door lock system, in accordance with one or more arrangements of the present disclosure.

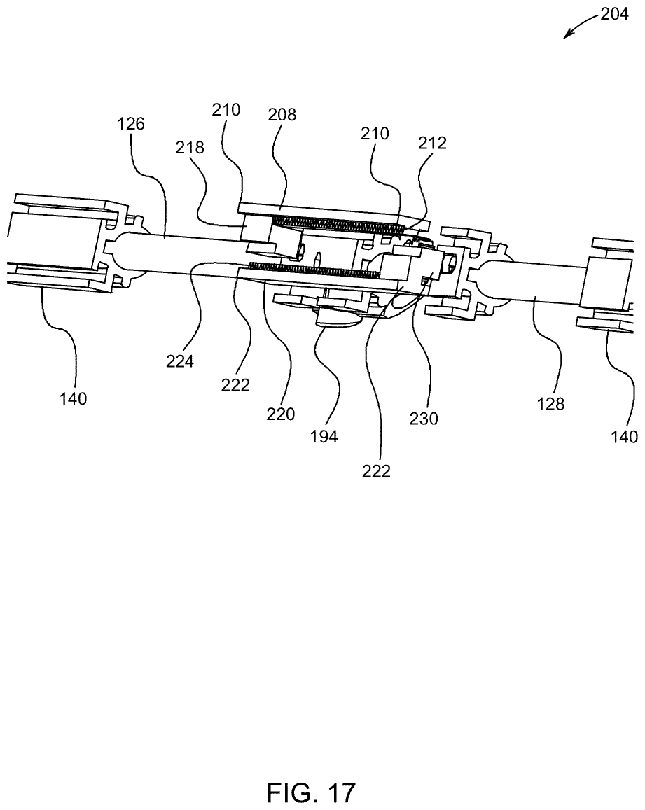

FIG. 18 shows a partial front view of a mechanical assembly of an internal assembly of a door lock system, in accordance with one or more arrangements of the present disclosure.

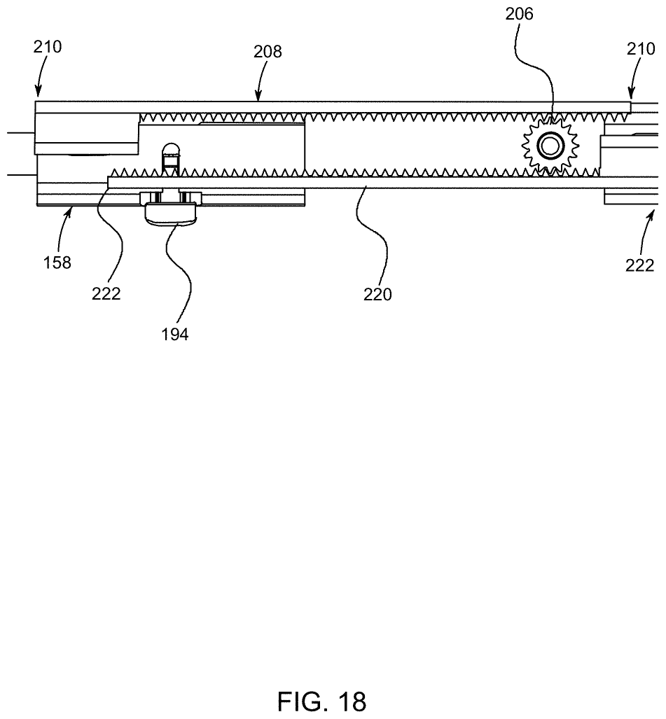

FIG. 19 shows a lower left front partial perspective view of an internal assembly of a door lock system, in accordance with one or more arrangements of the present disclosure; the view showing base, main body, and cover of an internal assembly omitted.

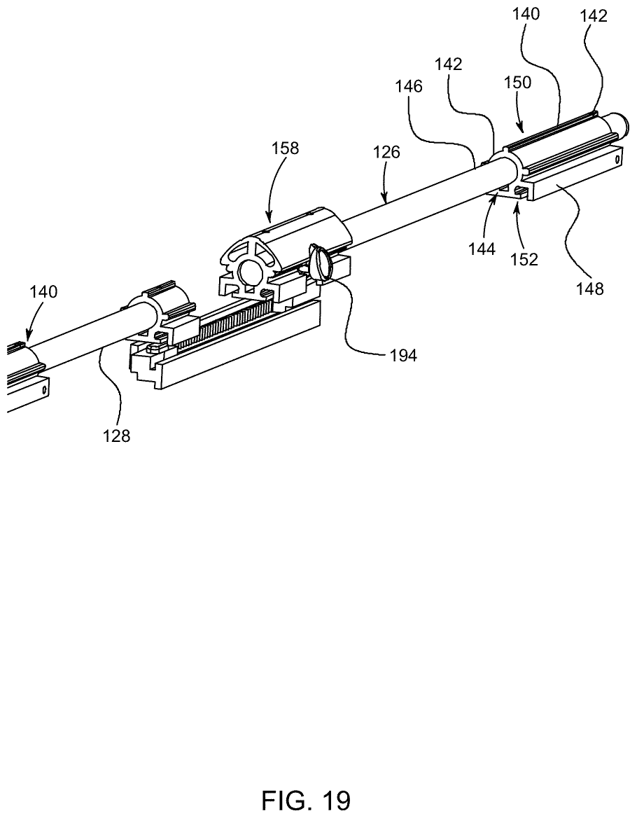

FIG. 20 shows an upper left front partial perspective view of an internal assembly of a door lock system, in accordance with one or more arrangements of the present disclosure; the view showing base, main body, and cover of an internal assembly omitted.

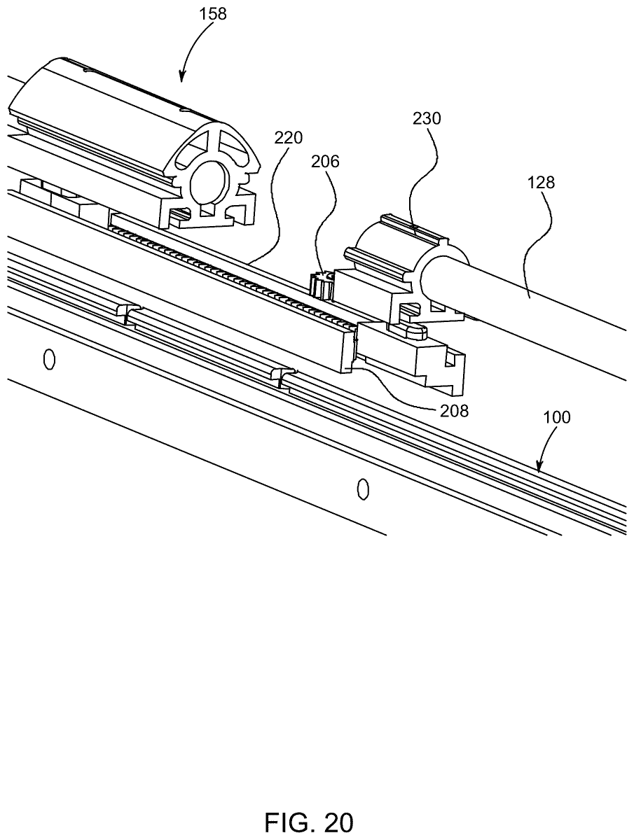

FIG. 21 shows a bottom partial view of an internal assembly of a door lock system, in accordance with one or more arrangements of the present disclosure; the view showing base, main body, and cover of an internal assembly omitted.

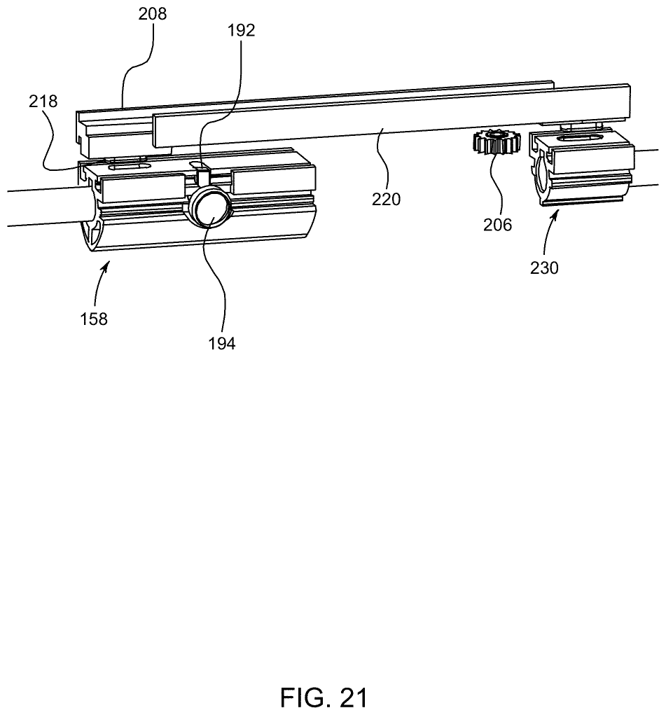

FIG. 22 shows an upper front left partial perspective view of an internal assembly of a door lock system, in accordance with one or more arrangements of the present disclosure; the view showing base, main body, and cover of an internal assembly omitted.

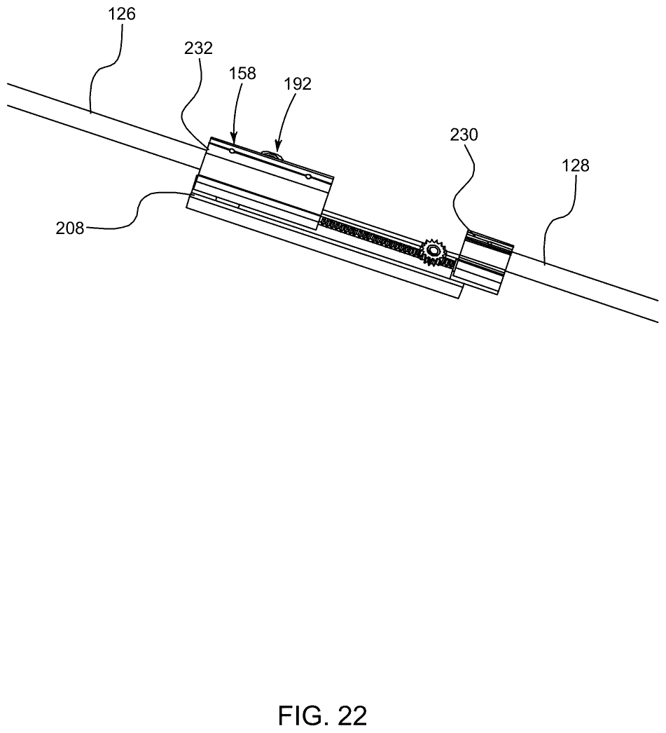

FIG. 23 shows an exploded front view of an internal assembly of a door lock system, in accordance with one or more arrangements of the present disclosure.

FIG. 24 shows an exploded bottom view of an internal assembly of a door lock system, in accordance with one or more arrangements of the present disclosure.

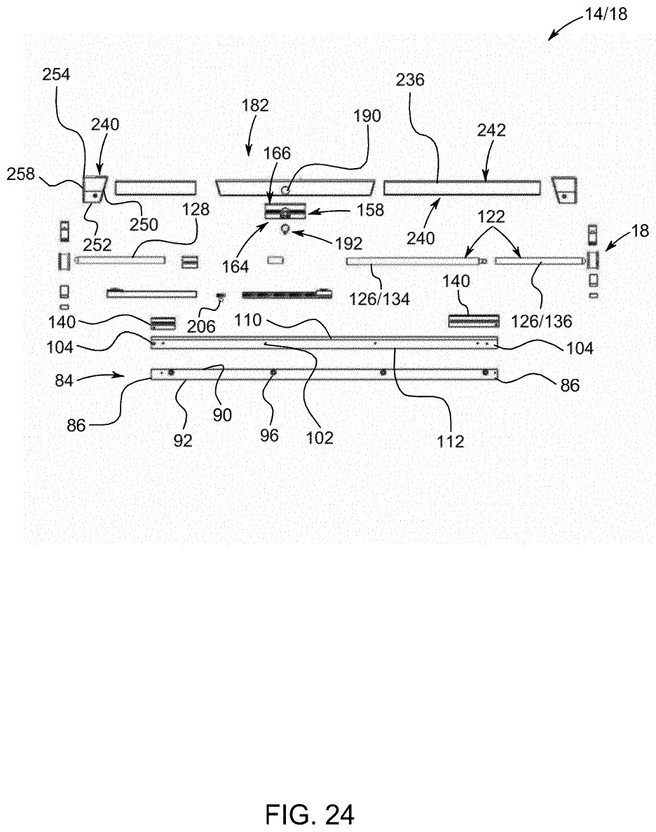

FIG. 25 shows an exploded top view of an internal assembly of a door lock system, in accordance with one or more arrangements of the present disclosure.

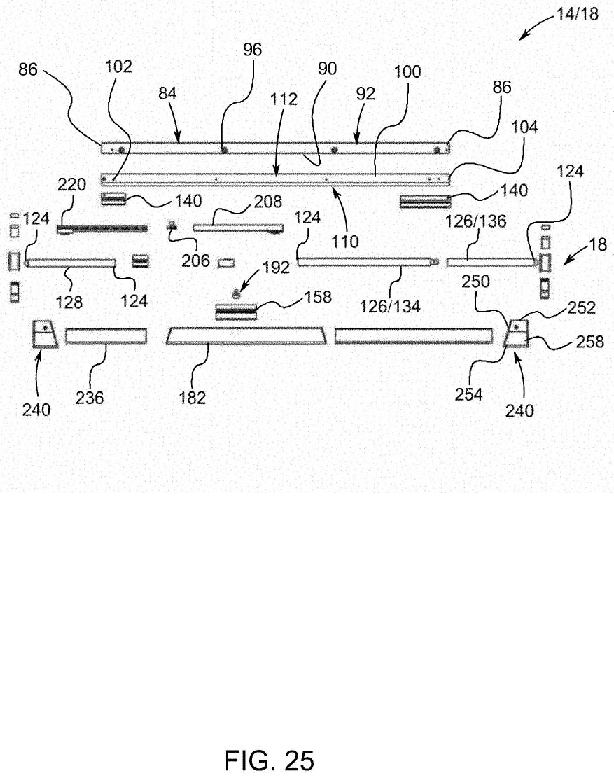

FIG. 26 shows an exploded front view of an internal assembly of a door lock system, in accordance with one or more arrangements of the present disclosure.

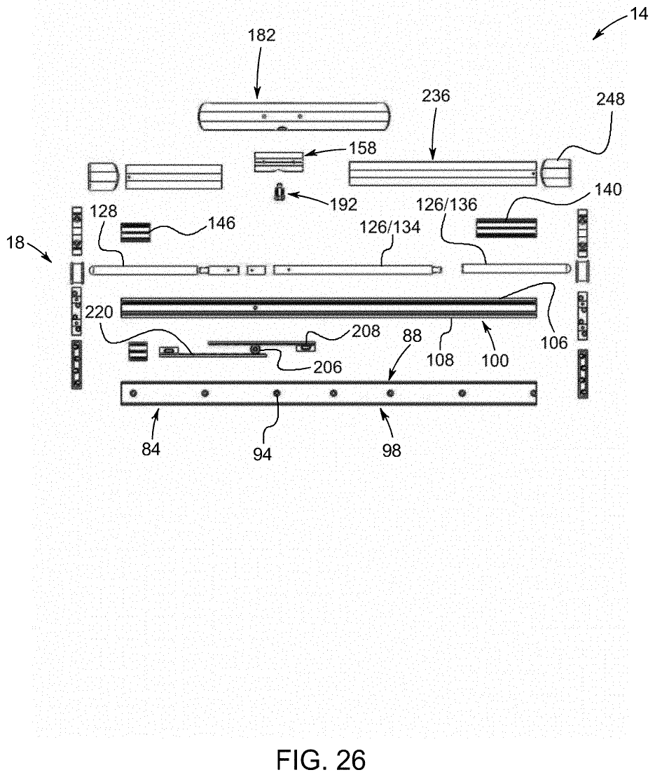

FIG. 27 shows an exploded lower front right perspective view of an internal assembly of a door lock system, in accordance with one or more arrangements of the present disclosure.

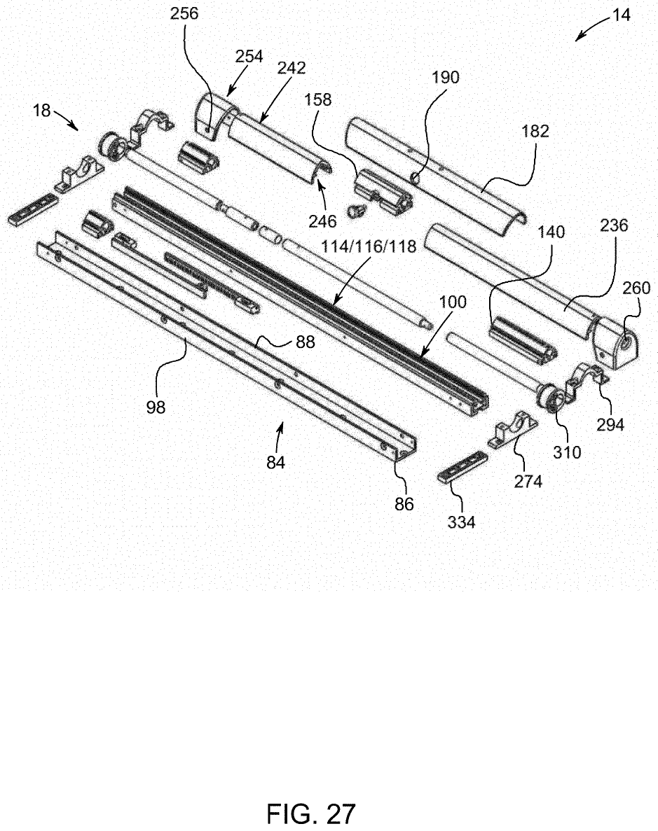

FIG. 28 shows an exploded upper front right perspective view of an internal assembly of a door lock system, in accordance with one or more arrangements of the present disclosure.

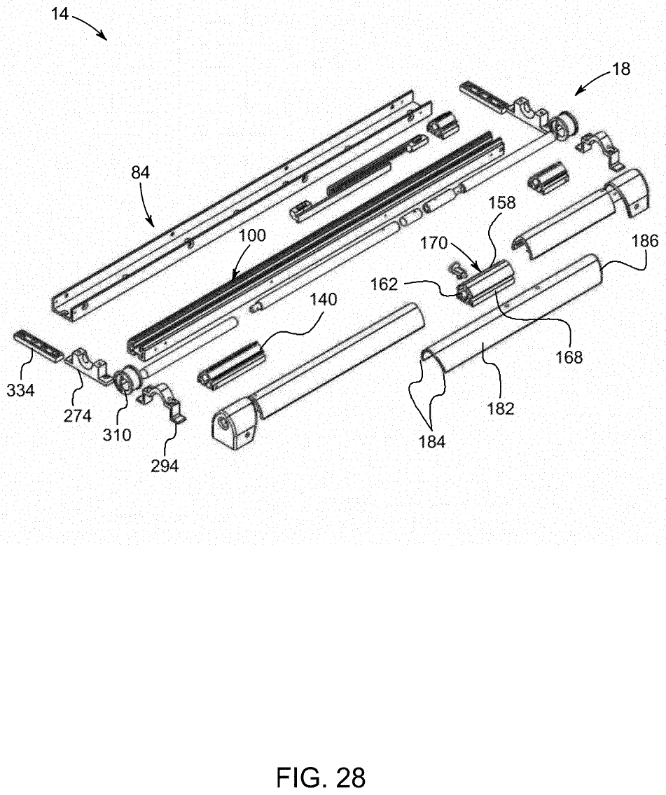

FIG. 29 shows an exploded upper front left perspective view of an internal assembly of a door lock system, in accordance with one or more arrangements of the present disclosure.

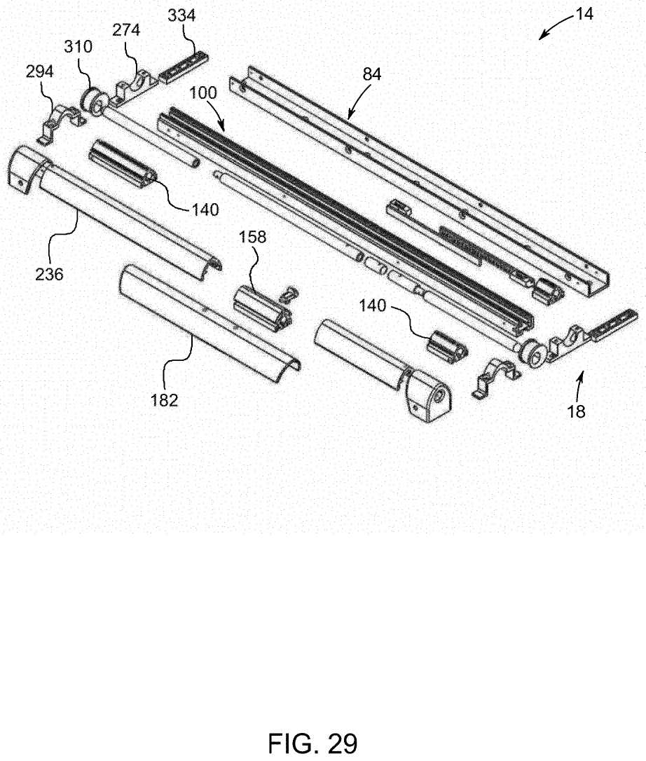

FIG. 30 shows an exploded lower front left perspective view of an internal assembly of a door lock system, in accordance with one or more arrangements of the present disclosure.

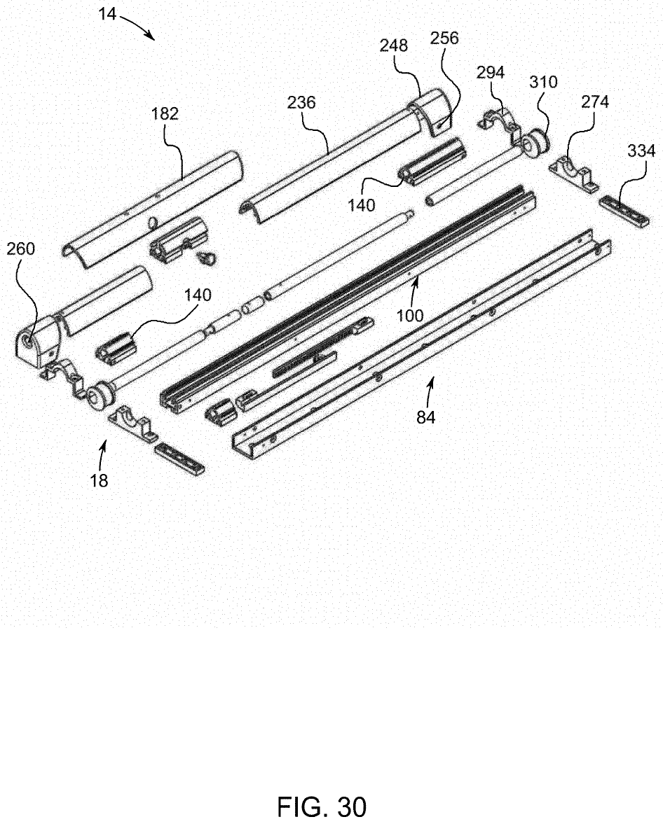

FIG. 31 shows an exploded right lower front perspective view of an internal assembly of a door lock system, in accordance with one or more arrangements of the present disclosure.

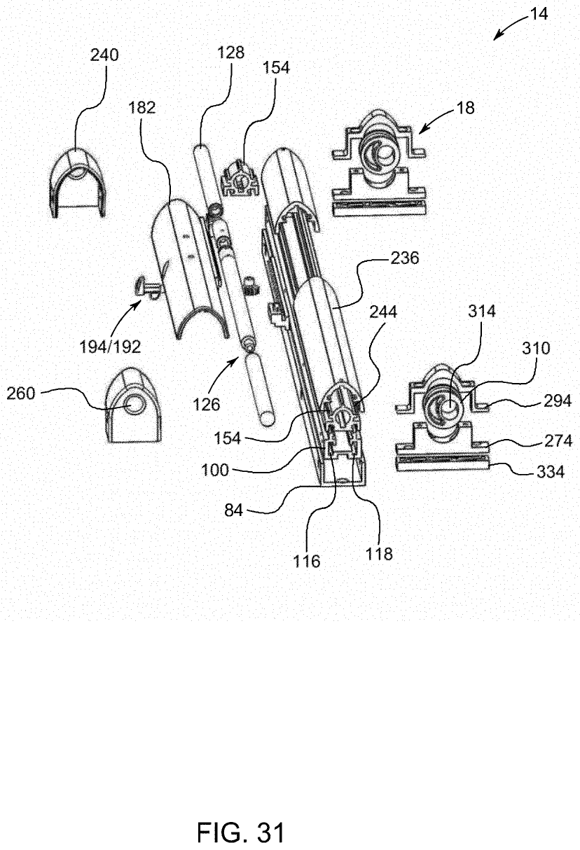

FIG. 32 shows an exploded left lower front perspective view of an internal assembly of a door lock system, in accordance with one or more arrangements of the present disclosure.

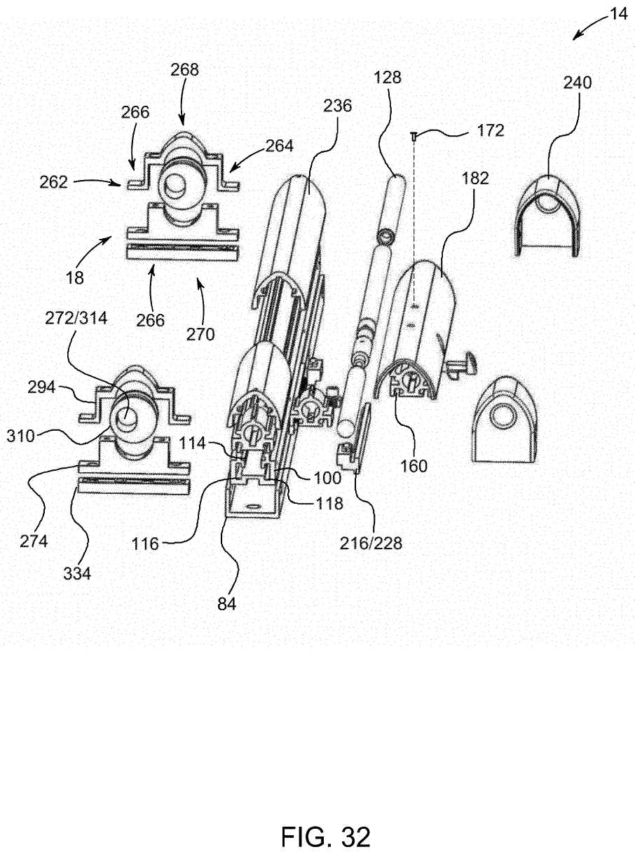

FIG. 33 shows an exploded upper front left perspective view of an internal assembly and end brackets of a door lock system and door, in accordance with one or more arrangements of the present disclosure.

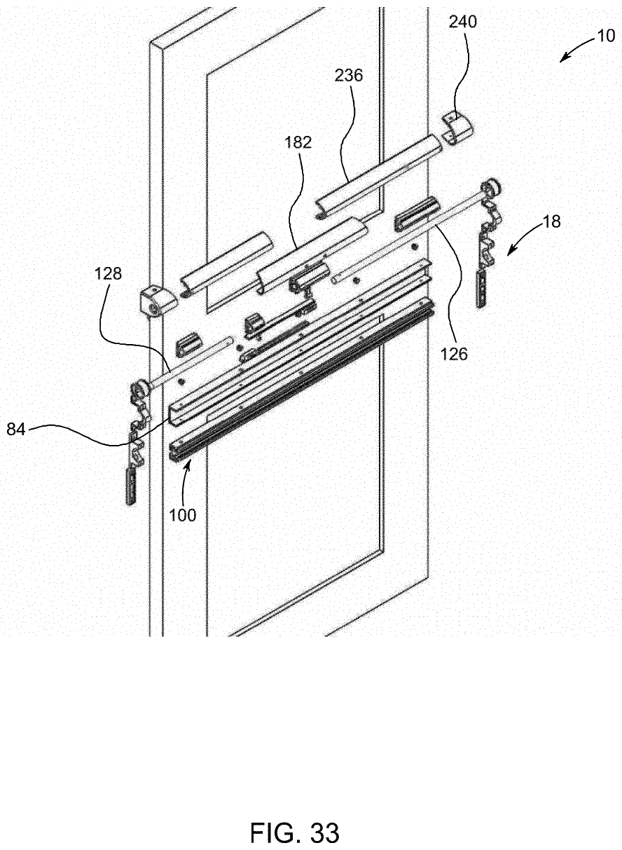

FIG. 34 shows an exploded upper front right perspective view of an internal assembly and end brackets of a door lock system and door, in accordance with one or more arrangements of the present disclosure.

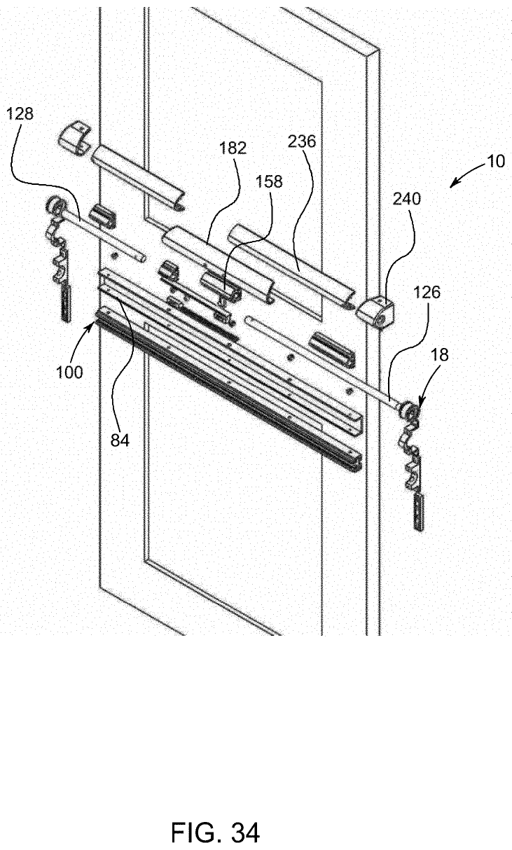

FIG. 35 shows an exploded left side view of a door lock system and door, in accordance with one or more arrangements of the present disclosure.

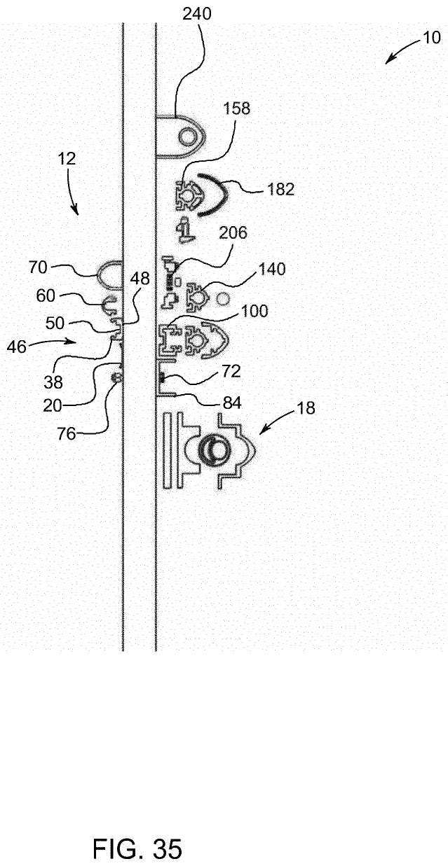

FIG. 36 shows an exploded right side view of a door lock system and door, in accordance with one or more arrangements of the present disclosure.

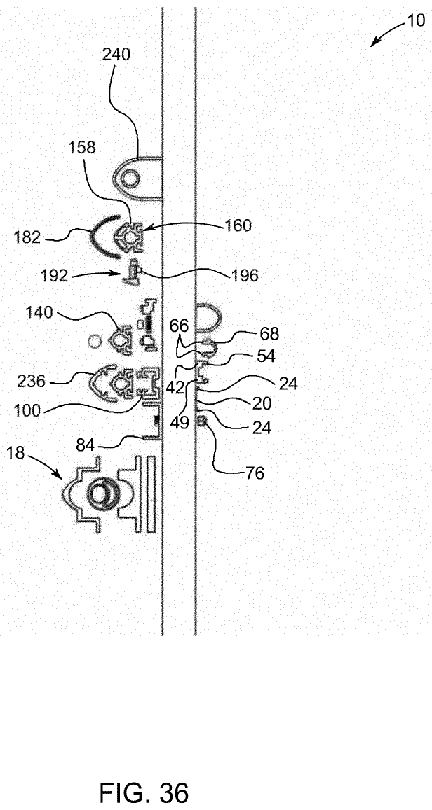

FIG. 37 shows an exploded left side view of a door lock system, in accordance with one or more arrangements of the present disclosure.

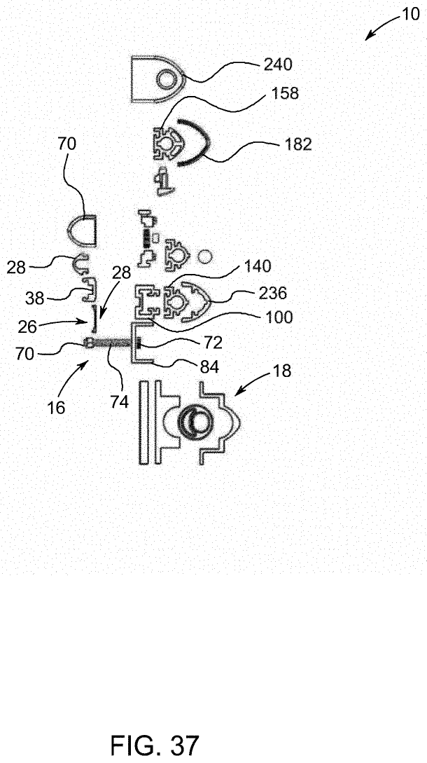

FIG. 38 shows an exploded right side view of a door lock system, in accordance with one or more arrangements of the present disclosure.

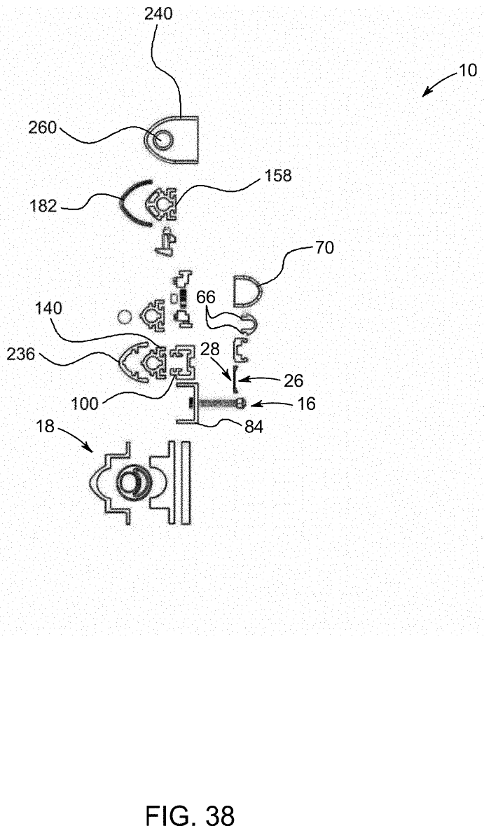

FIG. 39 shows an exploded exterior view of a door lock system and door, in accordance with one or more arrangements of the present disclosure.

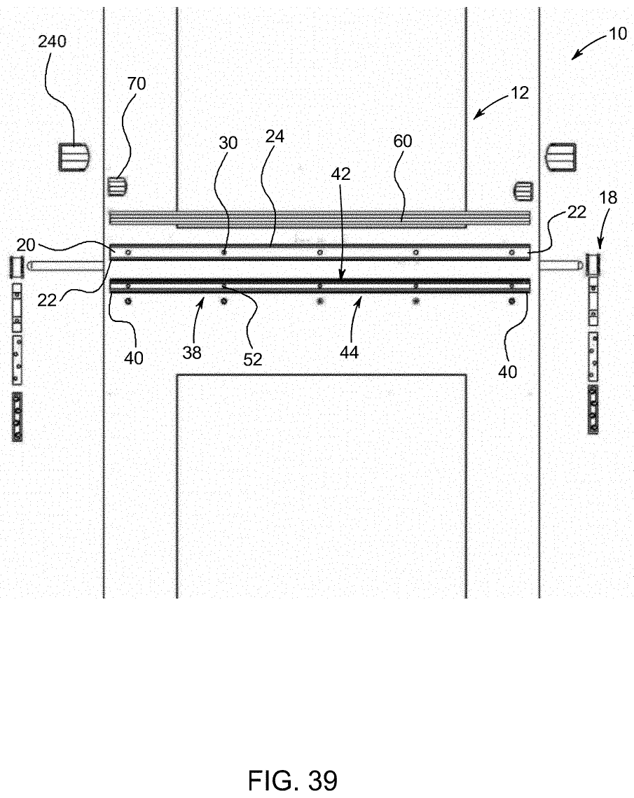

FIG. 40 shows an exploded exterior view upper right perspective view of a door lock system and door, in accordance with one or more arrangements of the present disclosure.

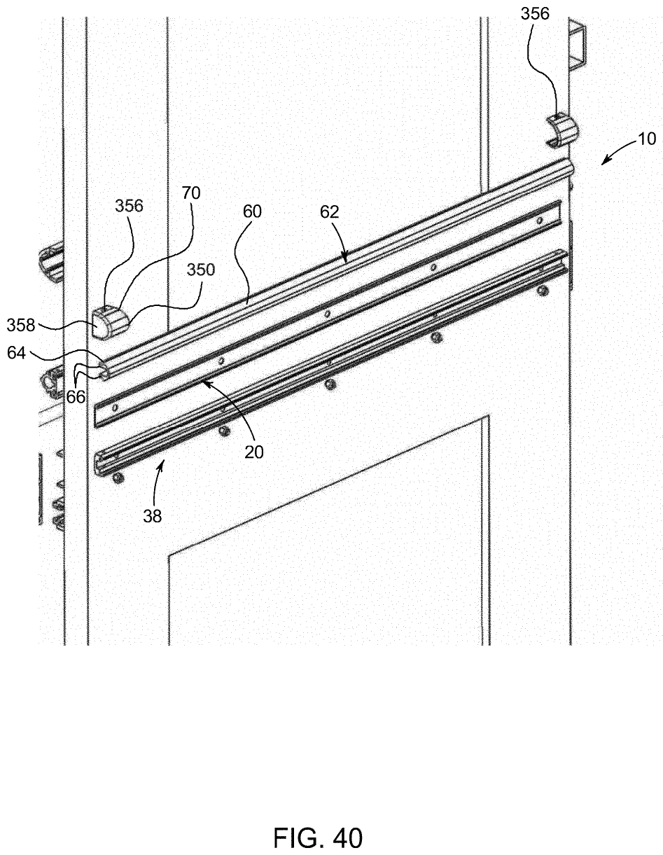

FIG. 41 shows a right side view of a door lock system and door, in accordance with one or more arrangements of the present disclosure.

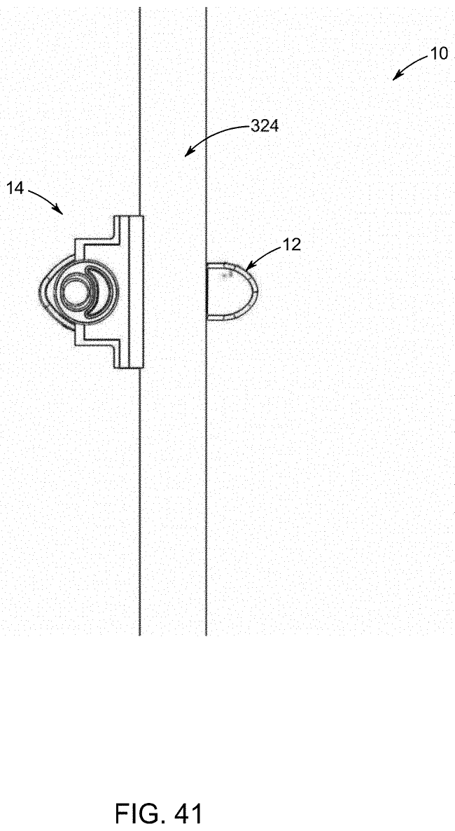

FIG. 42 shows a left side view of a door lock system, in accordance with one or more arrangements of the present disclosure.

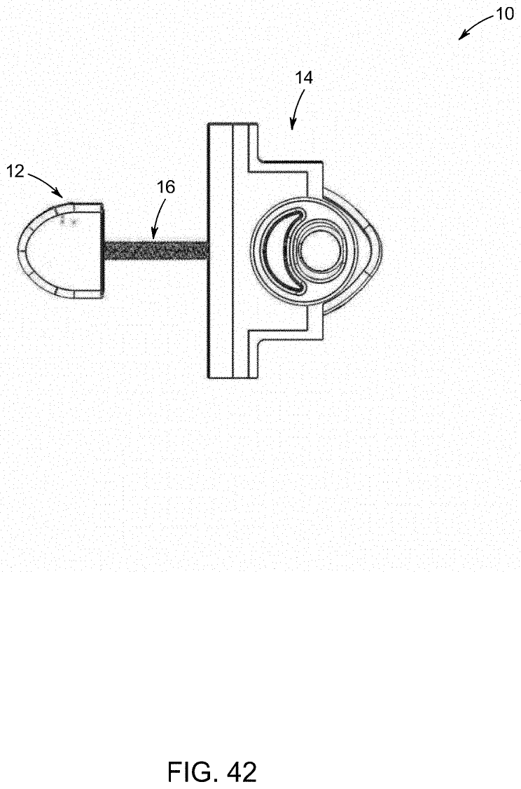

FIG. 43 shows a left side view of a door lock system, in accordance with one or more arrangements of the present disclosure.

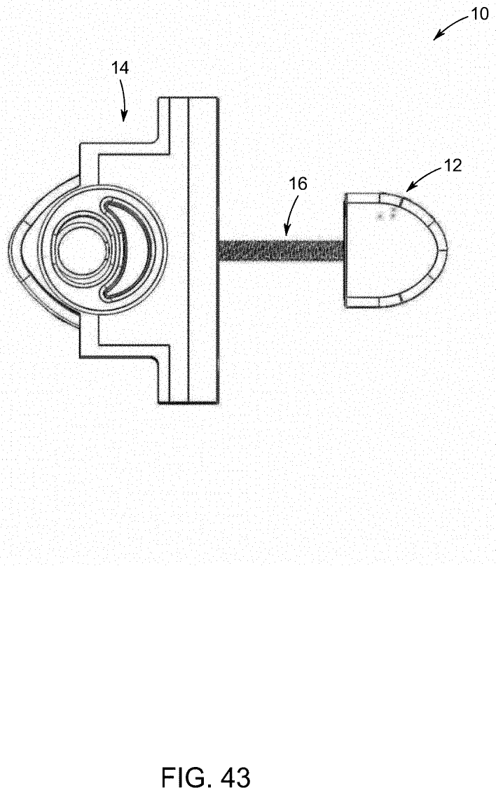

FIG. 44 shows an exploded right side view of an internal assembly of a door lock system, in accordance with one or more arrangements of the present disclosure.

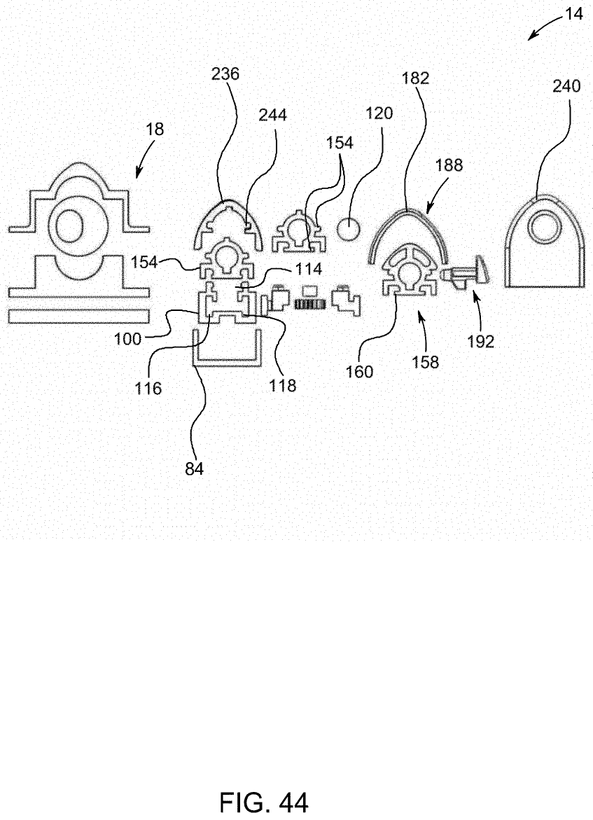

FIG. 45 shows an exploded left side view of an internal assembly of a door lock system, in accordance with one or more arrangements of the present disclosure.

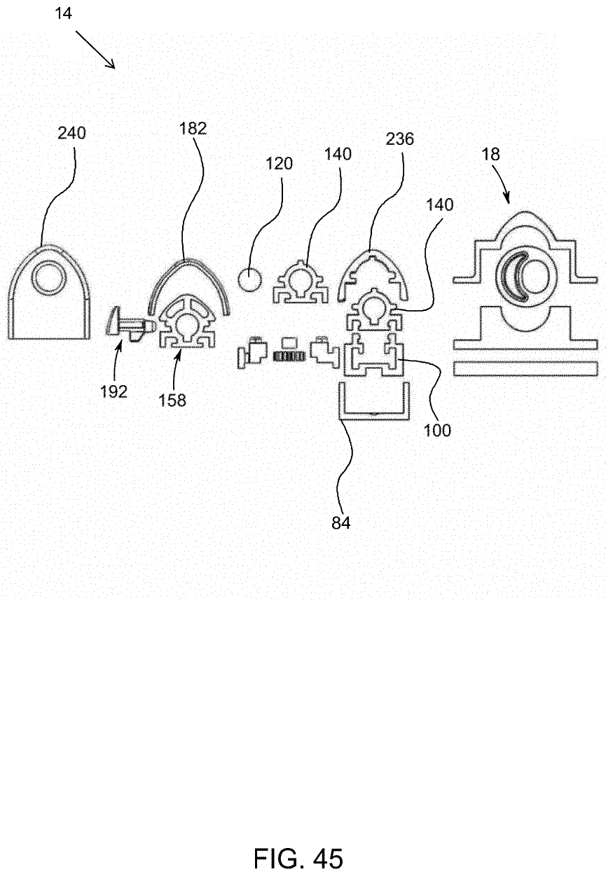

FIG. 46 shows a right side view of a door lock system, in accordance with one or more arrangements of the present disclosure; the view showing the door lock system installed on a door and door jam.

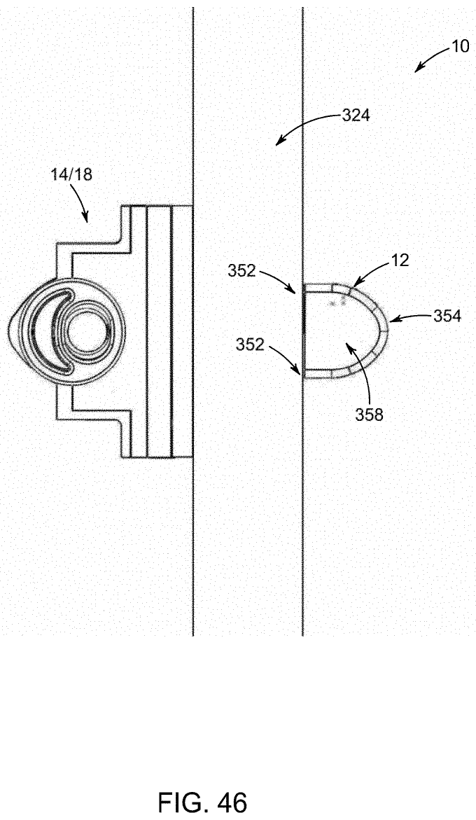

FIG. 47 shows an upper right inside perspective view of a door lock system, in accordance with one or more arrangements of the present disclosure; the view showing the door lock system installed on a door and door jam.

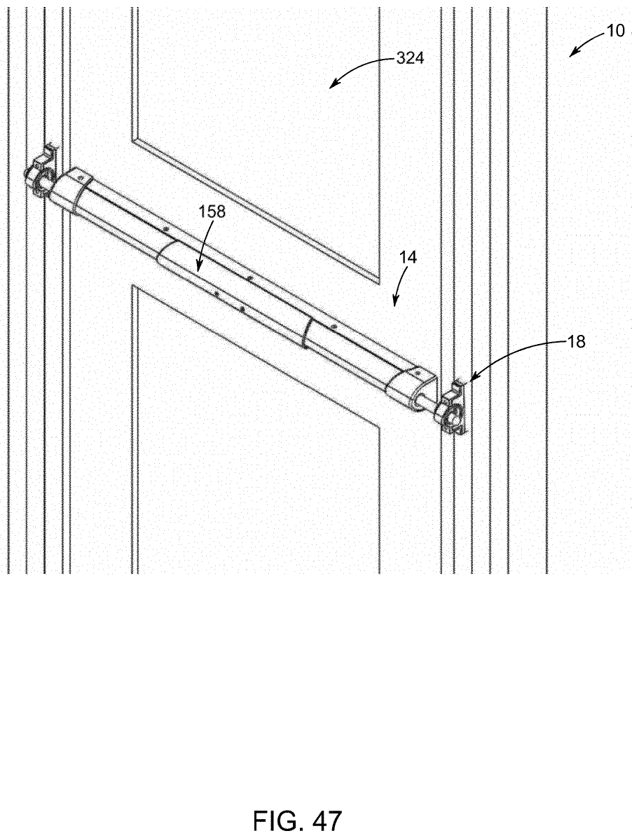

FIG. 48 shows an upper right outside perspective view of a door lock system, in accordance with one or more arrangements of the present disclosure; the view showing the door lock system installed on a door and door jam.

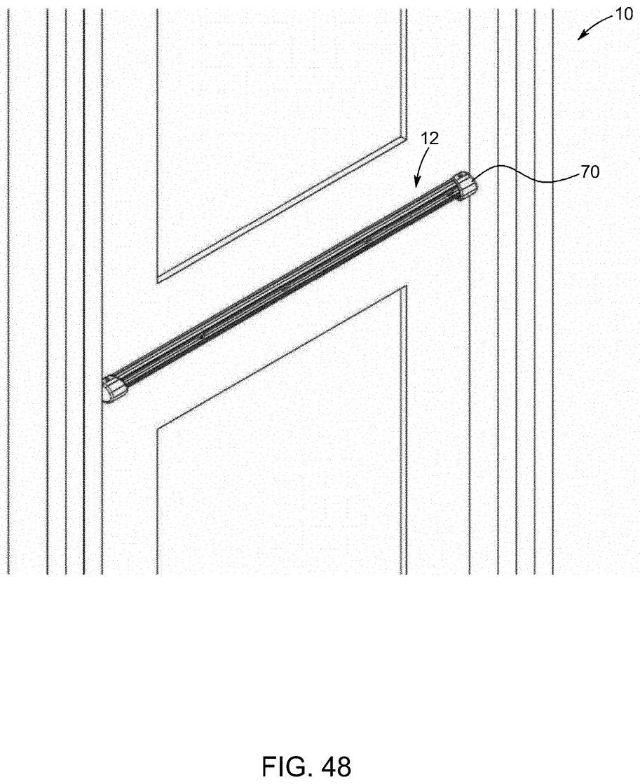

FIG. 49 shows an inside perspective view of a door lock system, in accordance with one or more arrangements of the present disclosure; the view showing the door lock system installed on a door and door jam.

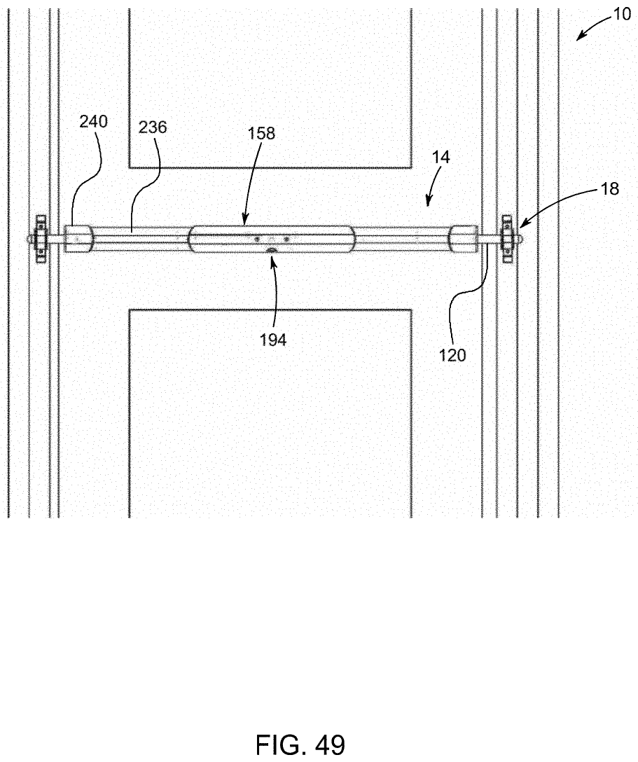

FIG. 50 shows an upper right inside perspective view of a door lock system, in accordance with one or more arrangements of the present disclosure; the view showing the door lock system installed on a door and door jam.

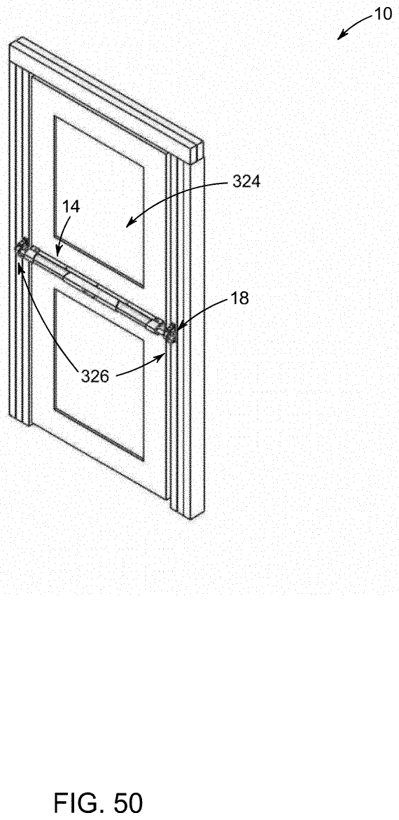

FIG. 51 shows an upper right outside perspective view of a door lock system, in accordance with one or more arrangements of the present disclosure; the view showing the door lock system installed on a door and door jam.

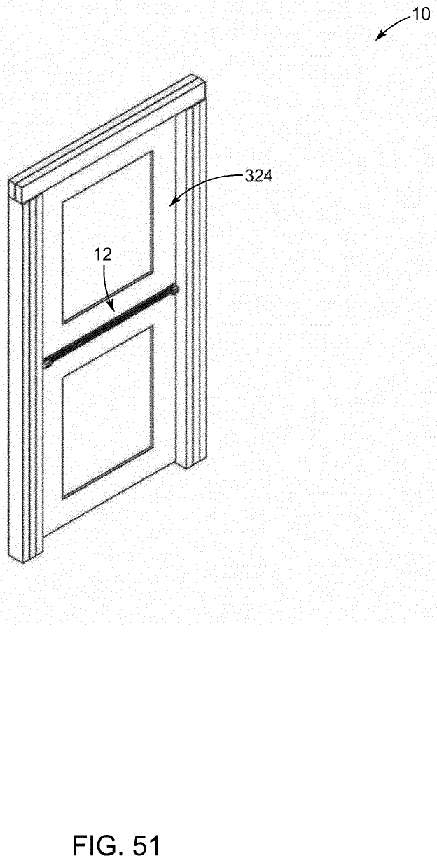

FIG. 52 shows a left side view of internal assembly and end brackets of a door lock system, in accordance with one or more arrangements of the present disclosure.

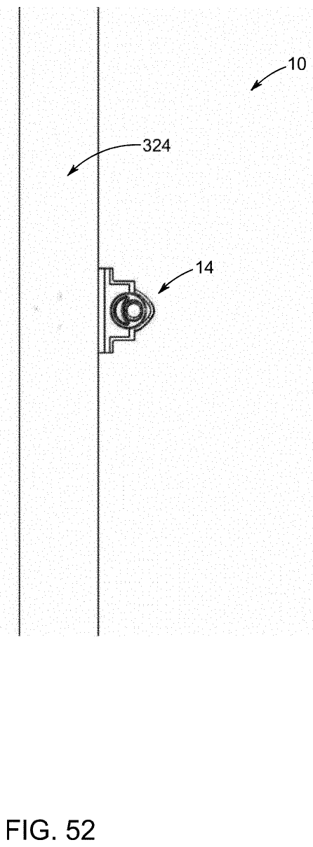

FIG. 53 shows an outside view of a door lock system, in accordance with one or more arrangements of the present disclosure; the view showing the door lock system installed on a door and door jam.

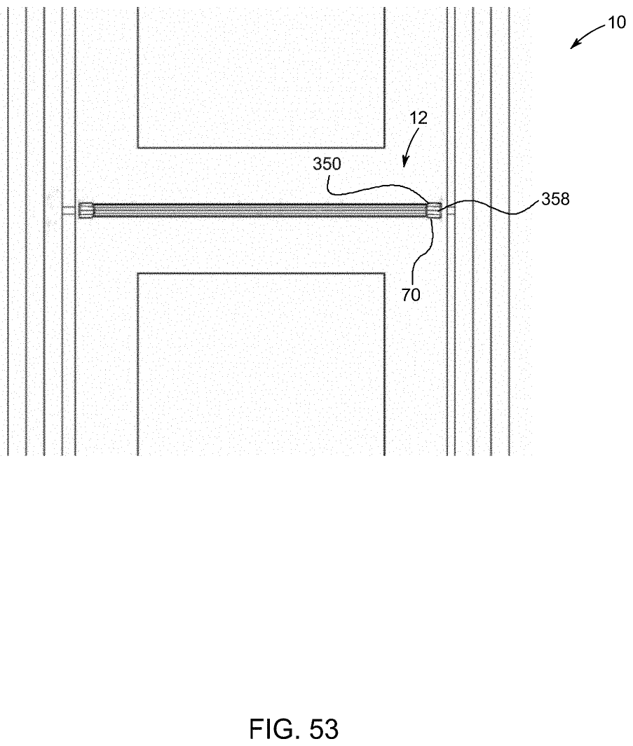

FIG. 54 shows a left side view of internal assembly and end brackets of a door lock system, in accordance with one or more arrangements of the present disclosure.

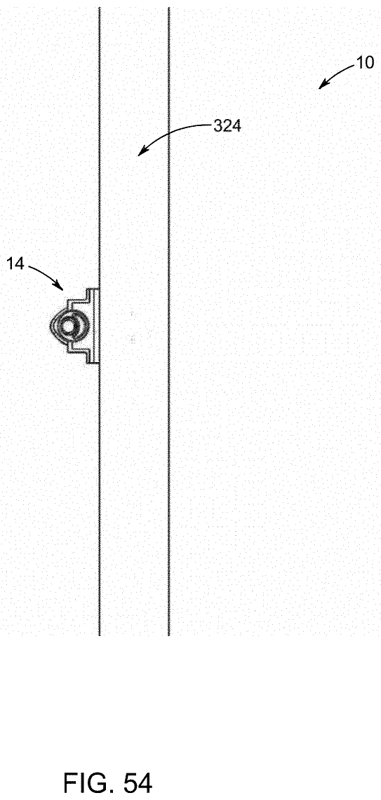

FIG. 55 shows a top view of a door lock system, in accordance with one or more arrangements of the present disclosure; the view showing the door lock system installed on a door.

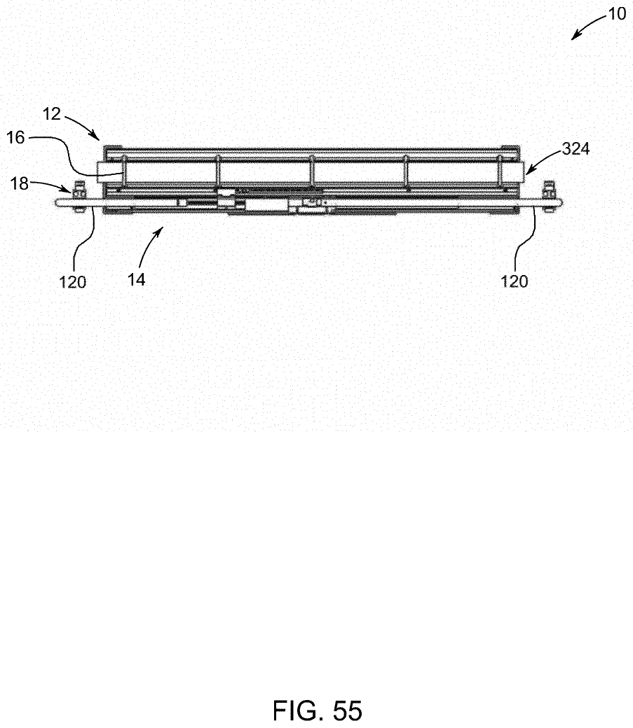

FIG. 56 shows a rear left perspective view of an end bracket of a door lock system, in accordance with one or more arrangements of the present disclosure.

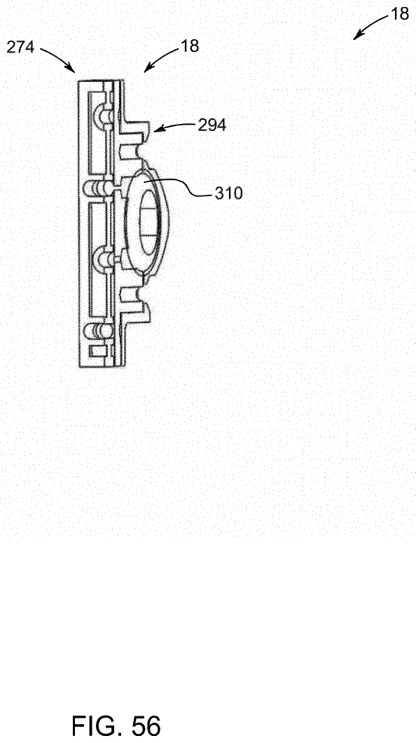

FIG. 57 shows an exploded front left perspective view of an end bracket of a door lock system, in accordance with one or more arrangements of the present disclosure.

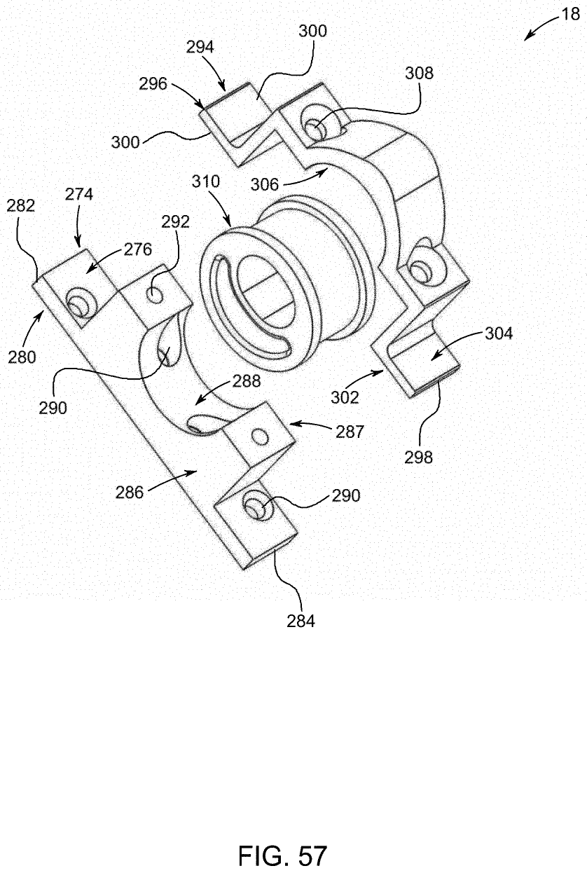

FIG. 58 shows an exploded front left perspective view of an end bracket of a door lock system, in accordance with one or more arrangements of the present disclosure.

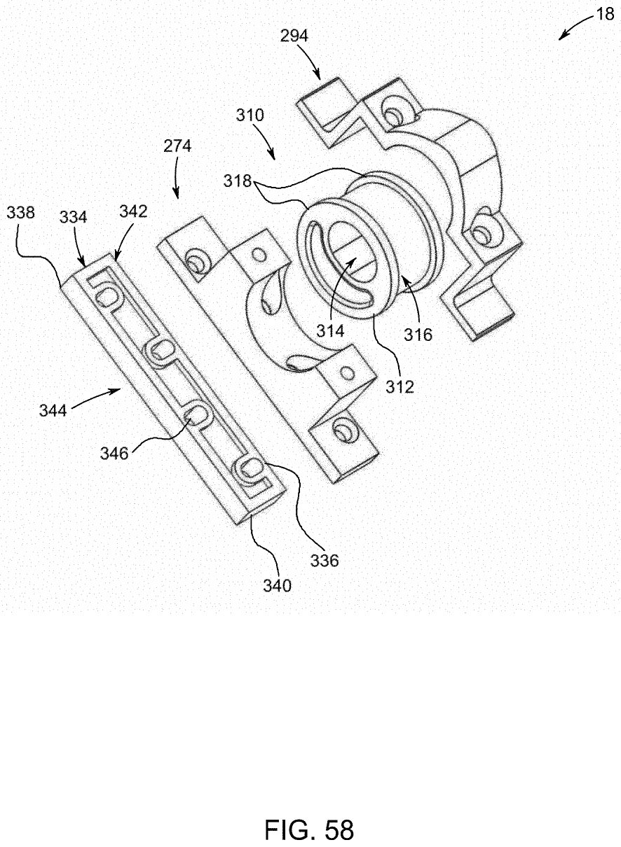

FIG. 59 shows left side view of an end bracket of a door lock system, in accordance with one or more arrangements of the present disclosure.

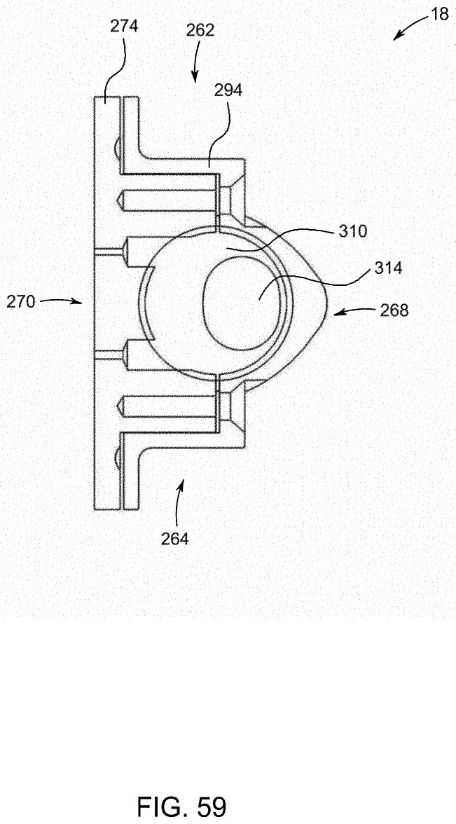

FIG. 60 shows left side view of an end bracket of a door lock system, in accordance with one or more arrangements of the present disclosure.

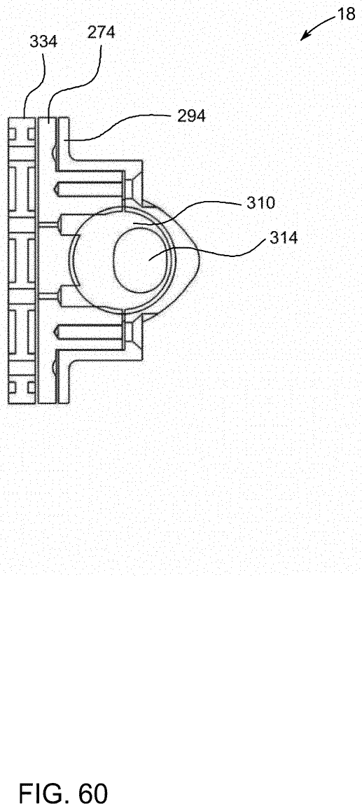

FIG. 61 shows an upper front right perspective view of an end bracket of a door lock system, in accordance with one or more arrangements of the present disclosure.

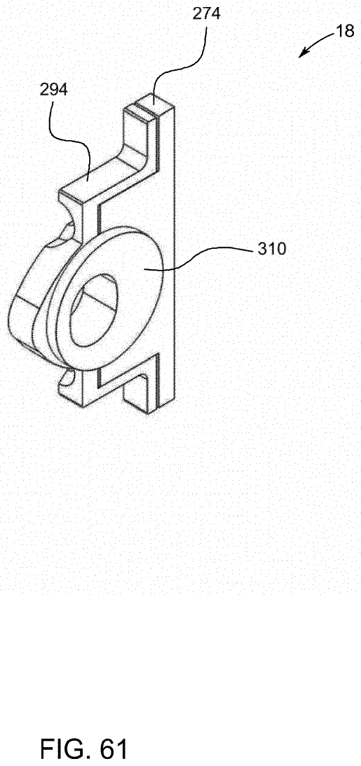

FIG. 62 shows an upper front left perspective view of an end bracket of a door lock system, in accordance with one or more arrangements of the present disclosure.

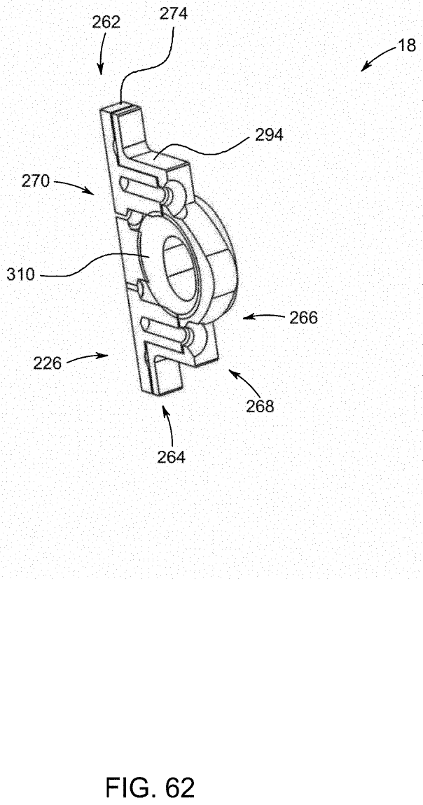

FIG. 63 shows a lower front left perspective view of an end bracket of a door lock system, in accordance with one or more arrangements of the present disclosure.

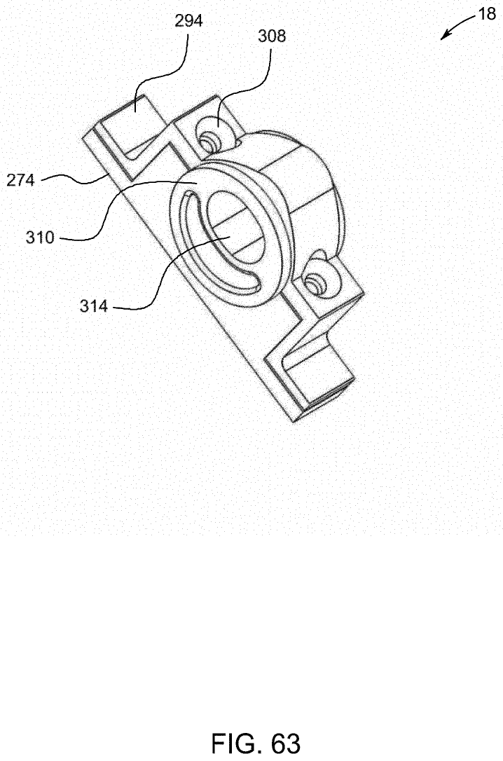

FIG. 64 shows a front left perspective view of an end bracket of a door lock system, in accordance with one or more arrangements of the present disclosure.

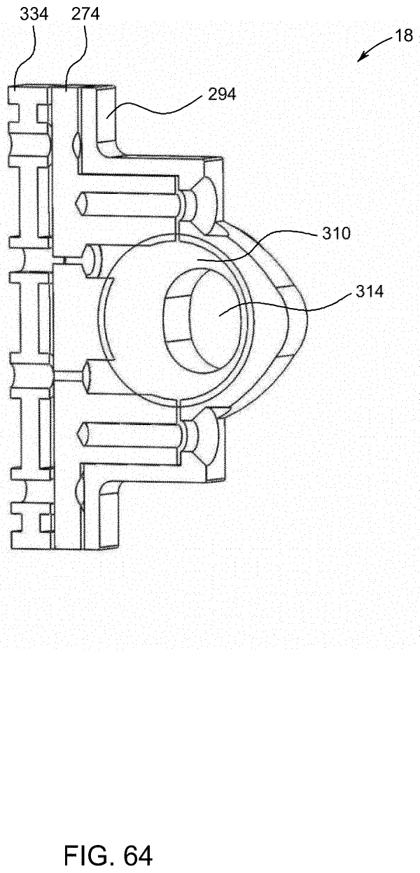

FIG. 65 shows an exploded lower right perspective view of a central member and latch of an internal assembly of a door lock system, in accordance with one or more arrangements of the present disclosure.

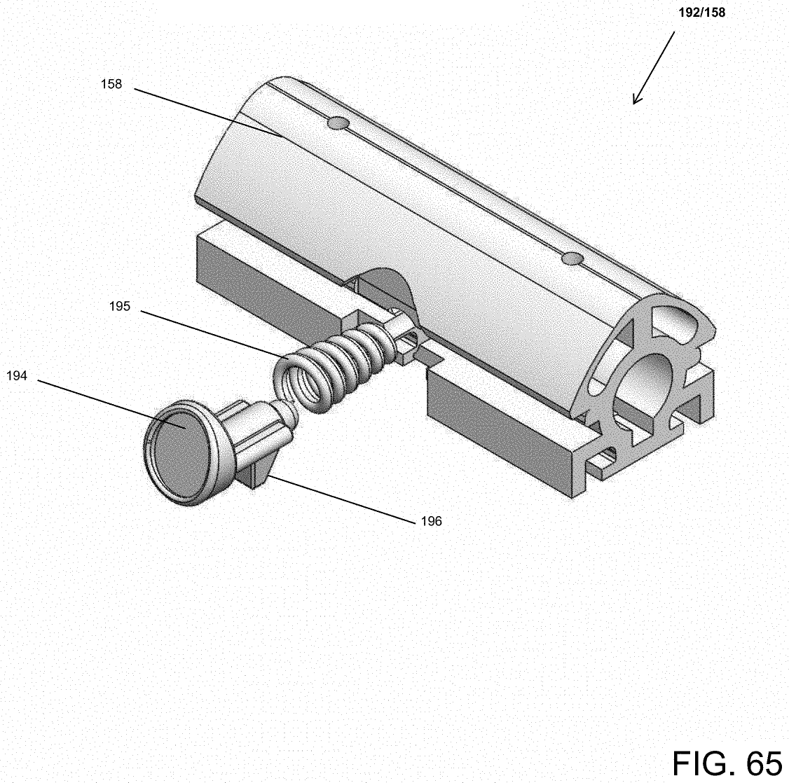

FIG. 66 shows an exploded front view of a central member and latch of an internal assembly of a door lock system, in accordance with one or more arrangements of the present disclosure.

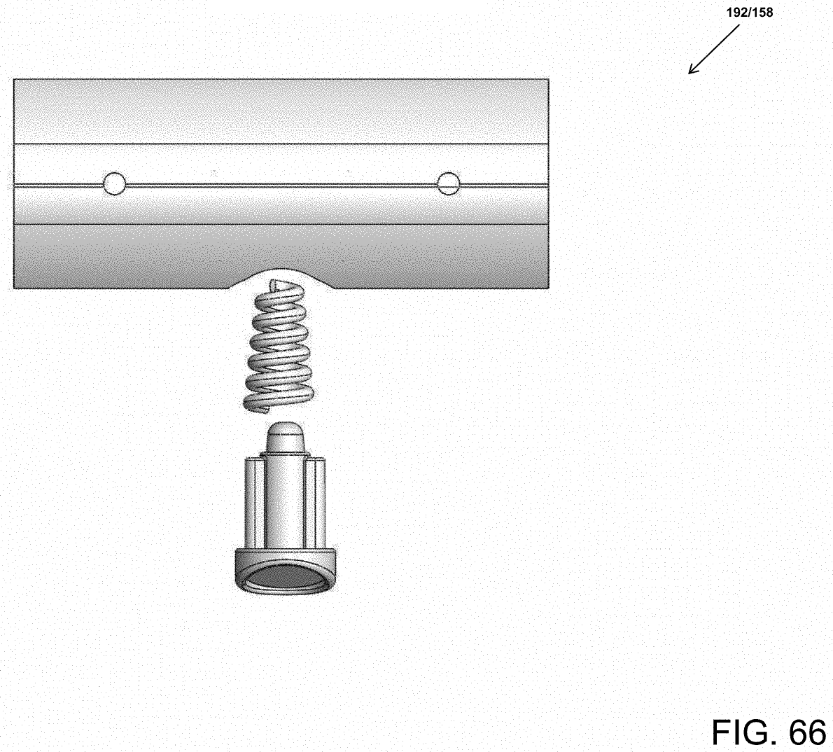

FIG. 67 shows an exploded front cross sectional view of a central member and latch of an internal assembly of a door lock system, in accordance with one or more arrangements of the present disclosure.

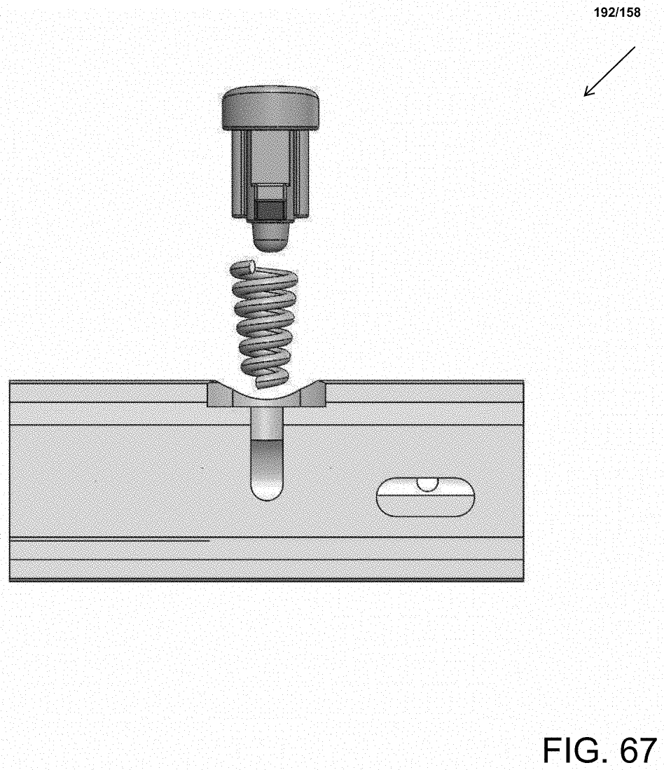

FIG. 68 shows an exploded lower left perspective view of a central member and latch of an internal assembly of a door lock system, in accordance with one or more arrangements of the present disclosure.

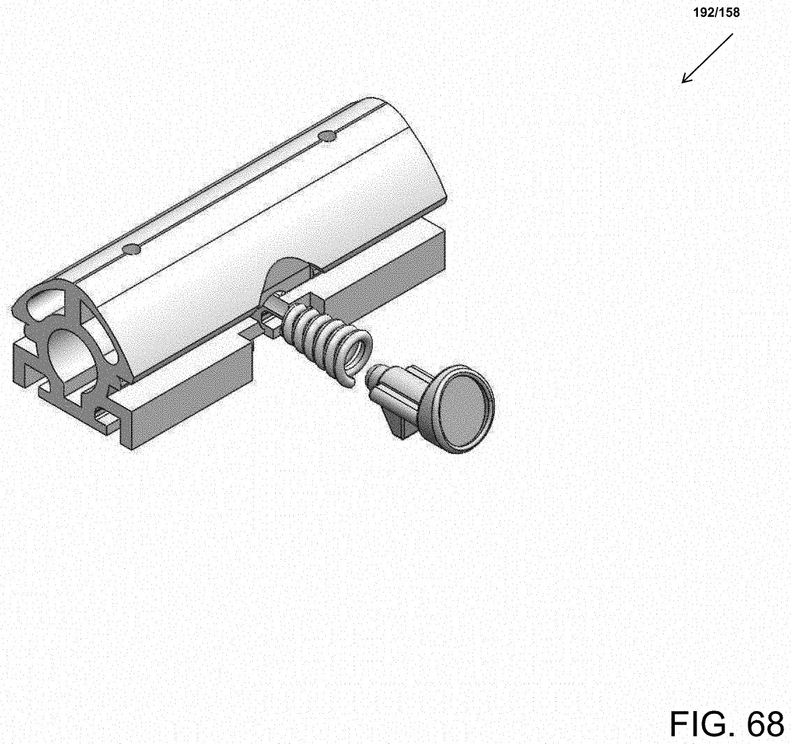

FIG. 69 shows an exploded front transparent view of a central member and latch of an internal assembly of a door lock system, in accordance with one or more arrangements of the present disclosure.

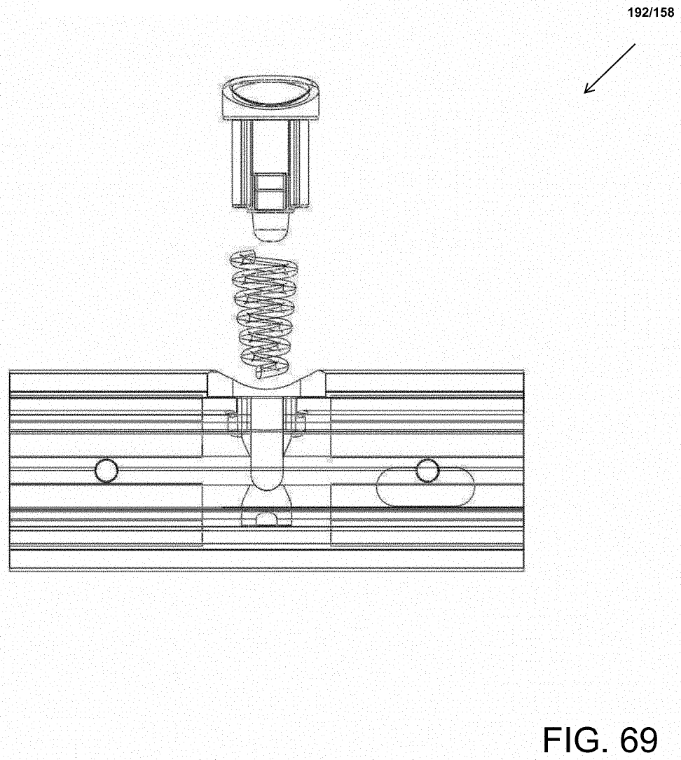

FIG. 70 shows an exploded lower front right perspective transparent view of a central member and latch of an internal assembly of a door lock system, in accordance with one or more arrangements of the present disclosure.

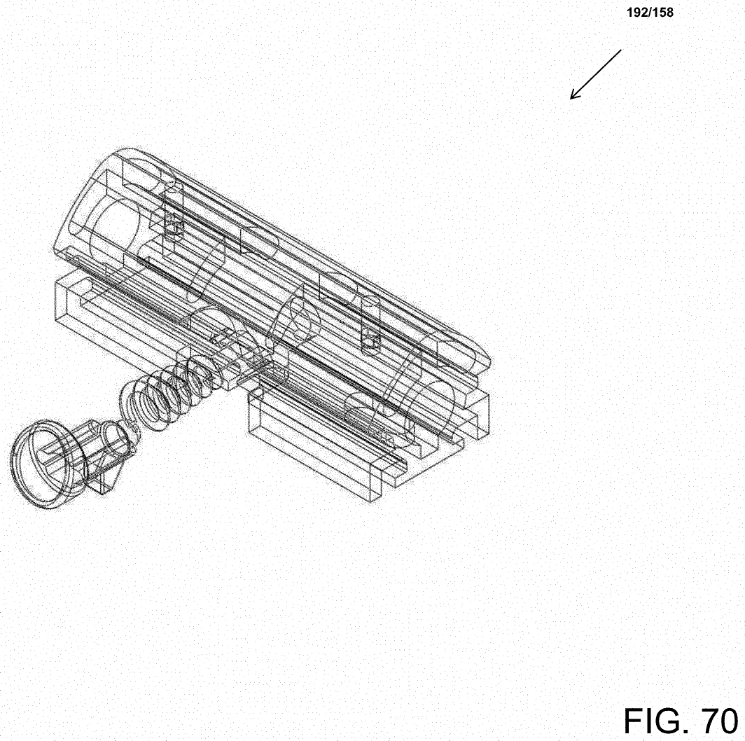

FIG. 71 shows an exploded lower front left perspective transparent view of a central member and latch of an internal assembly of a door lock system, in accordance with one or more arrangements of the present disclosure.

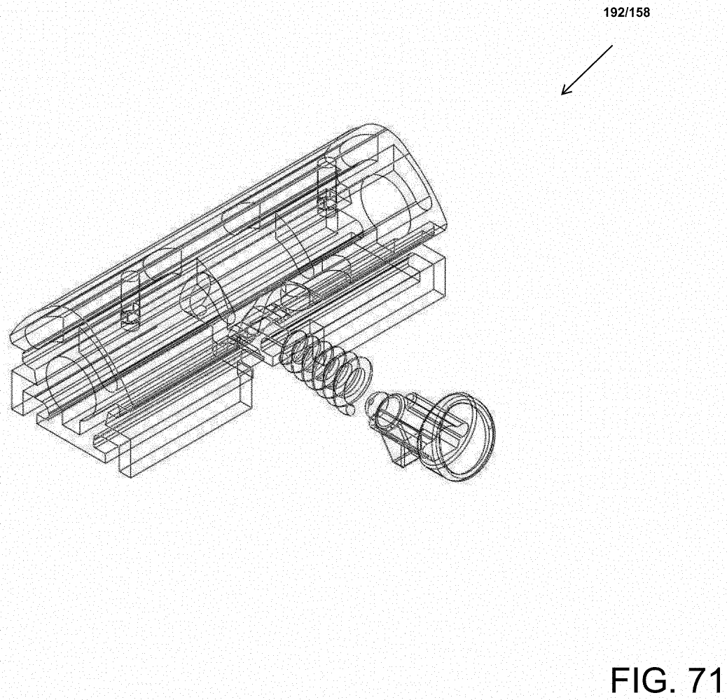

FIG. 72 shows an exploded right side transparent view of a central member and latch of an internal assembly of a door lock system, in accordance with one or more arrangements of the present disclosure.

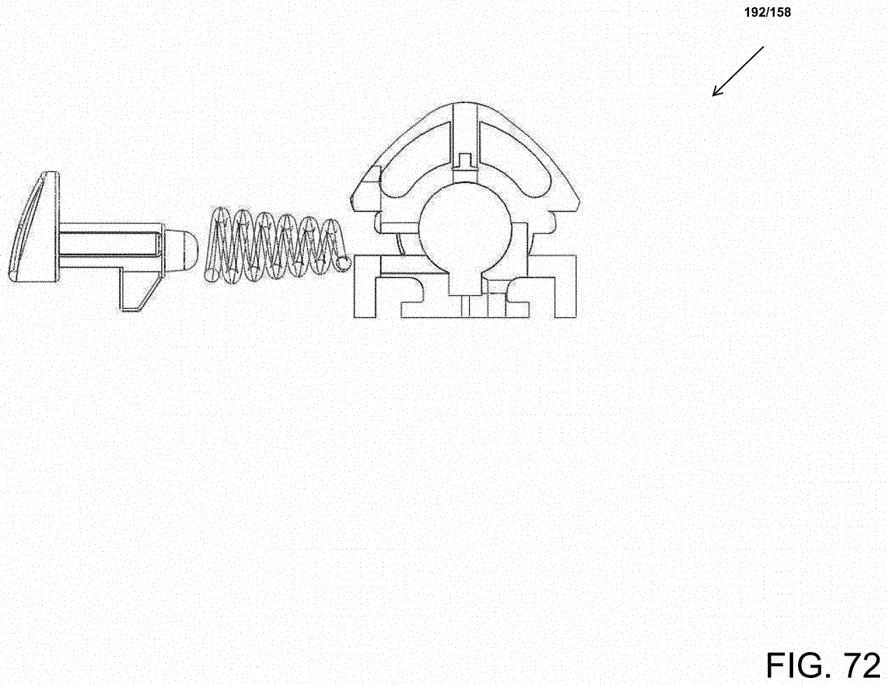

FIG. 73 shows an exploded rear transparent view of a central member and latch of an internal assembly of a door lock system, in accordance with one or more arrangements of the present disclosure.

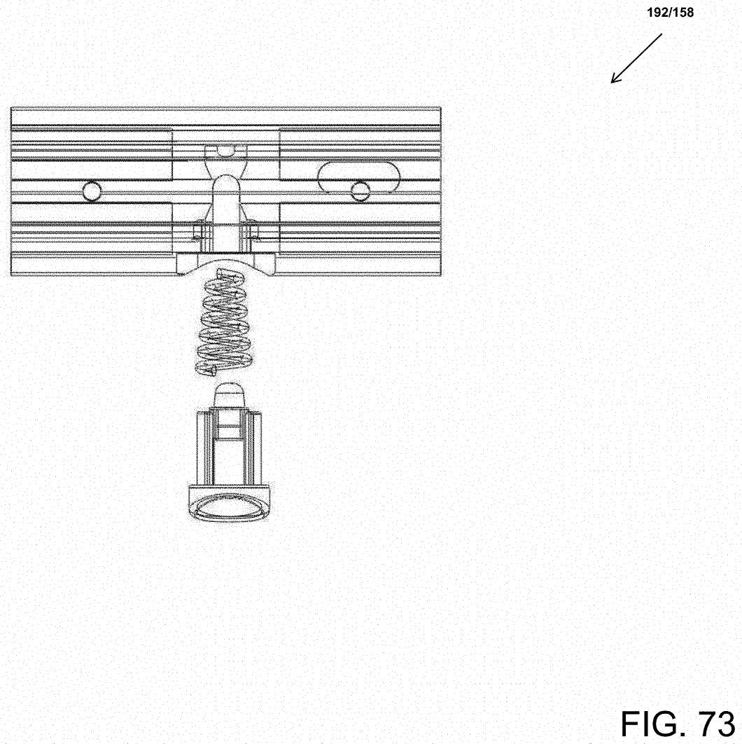

FIG. 74 shows a lower right side perspective view of a central member and latch of an internal assembly of a door lock system, in accordance with one or more arrangements of the present disclosure.

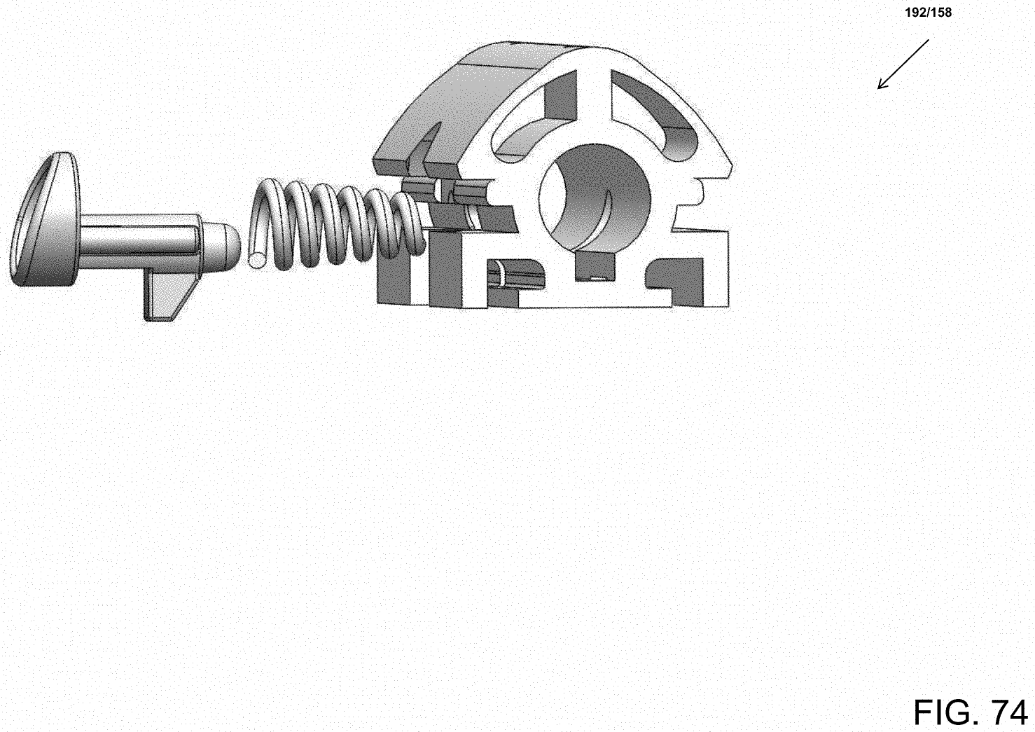

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure. Moreover, although some disclosed embodiments may be described in the context of securing doors, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “A but not B,” and “B but not A.” As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, the disclosure is shown and described as being used in association with locking and/or securing of doors. However, the disclosure is not so limiting. Instead, one of ordinary skill in the art will appreciate that the disclosed embodiments, presented herein, can be applied to various other devices, without limitation. The system is merely shown and described in the context of securing and locking of doors for ease of description and as one of countless example applications.

### System 10:

With reference to the figures, a door lock system 10 (or simply system 10) is presented. System 10 is formed of any suitable size, shape, and design and is configured to facilitate the locking and unlocking and/or reinforcement of a door. In an arrangement shown, as one example, system 10 includes the following component pieces: an exterior assembly 12, an interior assembly 14, a fastener 16, and end brackets 18, among other components.

As described in more detail in the following, in an arrangement shown, as one example, exterior assembly 12 is positioned on an exterior side of a door 324 and interior assembly 14 is positioned on an interior side of door 324. In this arrangement, fastener 16 connects exterior assembly 12 and interior assembly 14 through door 324 to provide a more secure attachment of system 10 to the door 324 and/or structurally reinforce the door 324 when attached.

### Exterior Assembly 12:

In one or more arrangements, system 10 includes an exterior assembly 12. Exterior assembly 12 is formed of any suitable size, shape, and design and is configured to attach to an exterior side of a door 324 and provide structural reinforcement. In an arrangement shown, as one example, exterior assembly 12 includes the following component pieces: a base 20, a main body 38, and a cover 60, among other components.

### Base 20:

In one or more arrangements, exterior assembly 12 includes a base 20. Base 20 is formed of any suitable size, shape, and design and is configured to facilitate attachment of exterior assembly 12 to the exterior side of door 324. In an arrangement shown, as one example, base 20 has a generally rectangular planar shape extending between opposing side edges 22 and top and bottom edges 24. In an arrangement shown, as one example, base 20 has a generally thin cross section between a rear surface 28 and a front surface 26, which extend generally parallel to each other.

In the arrangement shown, as one example, base 20 is configured for placement between door 324 and other components of exterior assembly 12. In one or more arrangements, for example, base 20 includes a number of holes 30 to facilitate connection between the door 324 and exterior assembly 12 through holes 30. In one or more arrangements, base may be formed of various materials including, but not limited to: rubber, plastics, metal, synthetic materials, and/or combinations thereof. In an example arrangement, base 20 may be formed of a compressible material (e.g., rubber or synthetic polymers) to provide padding to protect door 324 from unnecessary marking or denting by installation of exterior assembly 12. Additionally or alternatively, the compressible material may be configured to provide a weather proof seal where exterior assembly 12 contacts door 324, for example, to prevent water from getting behind exterior assembly 12 and damaging the door over time.

### Main Body 38:

In one or more arrangements, exterior assembly 12 includes a main body 38. Main body 38 is formed of any suitable size, shape, and design and is configured to facilitate attachment with interior assembly 14 by fastener 16 and/or provide structural reinforcement of door 324. In the arrangement shown, as one example, main body 38 has an elongated shape extending a length between opposing sides 40 proximate to opposing sides of door 324. In the arrangement shown, as one example, main body 38 has a top 42, a bottom 44, a front 46 and a rear 48.

In one or more arrangements, main body 38 has a recess 50 extending along the length of main body 38 in a surface of the front 46. Recess 50 is formed of any suitable size, shape, and design and is configured to facilitate attachment by fasteners 16 and/or prevent unauthorized removal of system 10 from the exterior side of door 324. In the arrangement shown, as one example, a recess 50 is shaped a channel extending along the length of main body 38 in a surface of the front 46. In this example arrangement, main body 38 includes a number of holes 52 located in the channel and extending though the rear 48 of main body 38. Holes 52 of main body 38 may be aligned with holes 30 of base 20 to facilitate connection by fasteners 16. In the arrangement shown, as one example, recess 50 is sized to permit head or nut of a bolt though a hole 52 to fit within the recess 50. In the arrangement shown, as one example, recess 50 is also sized to prevent the head or nut of such a bolt from rotating. In this manner, removal of the bolt from the exterior side of the door 324 is prevented.

### Cover 60:

In one or more arrangements, exterior assembly 12 includes a cover 60. Cover 60 is formed of any suitable size, shape, and design and is configured to enclose components of exterior assembly 12, while providing an aesthetically pleasing appearance. In the arrangement shown, as one example, cover 60 has an elongated shape extending a length between side edges 64. In the arrangement shown, as one example, the length of cover 60 is approximately equal to the length of main body 38. In this example arrangement, cover 60 has an exterior surface 62 with a generally curved shape extending between top and bottom rear edges 66.

In the arrangement shown, cover 60 includes one or more connection features 68 configured to connect with corresponding connection features 54 main body 38 of exterior assembly 12. Connection features 68 and 54 are formed of any suitable size, shape, and design and are configured to connect cover 60 to main body 38 of exterior assembly 12. In some arrangements, for example connection features 68 and 54 may include various mechanisms facilitate connection including, for example stapling, crimping, riveting, screwing, bolting, snap-fitting, friction fitting or any other mechanical process. In the shown arrangement, as one example, connection features 68 include a flange extending along rear edges 66 of cover 60 and are configured to engage a groove-shaped connection feature 54 extending the length of main body 38.

In some arrangements, cover 60 may be configured to be attached to main body 38 aligning and inserting connection features 68 into connection features 54 at a side 40 of main body 38 and sliding cover 60 into place from the side. In some other arrangements, cover 60 may be configured to be attached to main body 38 from the front by snapping connection features 68 into connection features 54 of main body 38.

### End Covers 70:

End covers 70 are formed of any suitable size, shape, and design and are configured to functionally cover sides 22 of base 20, sides 40 of main body 38, and sides 64 of cover, while providing an aesthetically pleasing appearance.

In the arrangement shown, as one example, end covers 70 have a front surface 354 extending between an exterior side 358 and an inner edge 350. Front surface 354 extends over ends of exterior assembly 12 between top and bottom rear edges 352. In the arrangement shown, exterior side 358 of each end cover 70.

In different arrangements, end covers 70 may be attached to main body 38, base 20, and/or other components of exterior assembly 12 using various connection techniques known in the art including, for example, adhesives, epoxies, welding, stapling, crimping, riveting, screwing, bolting, snap-fitting, friction fitting, and/or any other known chemical and mechanical connection techniques. In the arrangement shown, as one example, end covers 70 include holes 356 for attachment of end covers 70 to main body 38 and base 20 with screws.

### Fasteners 16

In one or more arrangements, system 10 includes fasteners 16 configured to connect exterior assembly 12 to interior assembly 14 through door 324. Fasteners 16 are formed of any suitable size, shape, and design and are configured to facilitate connection of exterior assembly 12 to interior assembly 14. In the arrangement shown, as one example, fasteners 16 include threaded bolts 74, each having a fixed head 72 and a nut 76 with threads complimentary to those of threaded bolt 74. In the arrangement shown, as one example, the threaded bolts 74 connect interior assembly and exterior assembly 12 through a set of aligned holes through door 324, interior assembly 14, and exterior assembly 12.

### In Operation

As an illustrative example, installing of system 10, a threaded bolt 74 may be inserted through a hole 94 interior assembly 14, through an aligned hole in door 324, and further through aligned holes 30 and/or 52 of exterior assembly 12. The fastener 16 may be extended through and beyond main body 38 of exterior assembly 12 by an amount permitting a nut 76 to be threaded onto threaded bolt 74 from the exterior side of door 324. After threading the nut 76 onto threaded bolt 74, the threaded bolt is moved back toward the interior side of the door 324 to cause nut 76 to be inserted into recess 50 of main body 38 of exterior assembly 12. In the arrangement shown, for example, recess 50 of exterior assembly 12 is sized to hold and prevent rotation of the nut 76. With nut 76 in recess 50, head 72 of threaded bolt 74 may be rotated from the interior side of door 324 to tighten the threaded bolt 74 of fastener 16.

As a result of tightening threaded bolt 74 of fastener 16, interior assembly 14 and exterior assembly 12 are pulled toward one another. In this manner, interior assembly 14 and exterior assembly are attached to door 324 by fastener 16. After tightening fasteners 16, cover 60 of exterior assembly 12 may be installed as previously described, to hide nuts 76 and provide an aesthetically pleasing appearance.

In one or more arrangements, the attachment of interior assembly 14 and exterior assembly 12 together though the door with threaded bolts 74 may beneficially provide a more secure attachment of the system 10 to the door. Additionally or alternatively, connection of interior assembly 14 and exterior assembly may compress materials of door 324 between interior assembly 14 and exterior assembly 12.

Compression of door 324 between the elongated interior and exterior assemblies 12/14 provides additional structural support for the door and/or may inhibit delamination of door materials. In high wind events (e.g., hurricanes), a high positive and negative high wind pressures and/or impact from windborne debris may cause door 324 to flex and/or bend while in a locked/closed position. Repeated flexing and/or bending during severe weather events, can cause door materials to delaminate, severely weakening strength of the door. By compressing door 324 between interior and exterior assemblies 12 and 14 delamination of door materials can be prevented.

### Interior Assembly 14:

In one or more arrangements, system 10 includes an interior assembly 14. Interior assembly 14 is formed of any suitable size, shape, and design and is configured to attach to an exterior side of a door 324 and selectable connect with end brackets 18 for locking of the door 324. In an arrangement shown, as one example, interior assembly 14 includes the following component pieces: a base 84, a main body 100, locking bolts 120, bolt collars 140, a center member 158, a mechanical assembly 204, and covers 236/248 among other components.

### Base 84:

In one or more arrangements, interior assembly 14 includes a base 84. Base 84 is formed of any suitable size, shape, and design and is configured to facilitate attachment of interior assembly 14 to an interior side of door 324. In an arrangement shown, as one example, base 84 has an elongated shape extending a length between opposing sides 86. Base 84 has a top 88 and a bottom 98 connected to a rear 112. In the arrangement shown, as one example, base 84 has an open front. In the arrangement shown, as one example, top 88, a bottom 98, and sides 86 are oriented in a generally rectangular shape, when viewed from front 110.

In the arrangement shown, as one example, base 84 of interior assembly 14 is configured and arranged to attach to door 324 with a surface of rear 92 in contact with door 324. However, in some arrangements, base 84 may be separated from the door by one or more additional materials. As an illustrative example, in some arrangements, base 84 may be separated from the door by a compressible padding layer configured to provide a tight fit between base 84 and door 324.

In various arrangements, base 84 may be attached to door 324 using mechanisms techniques including, for example, stapling, crimping, riveting, screwing, bolting, snap-fitting, friction fitting or any other mechanical process. In the shown arrangement, as one example, base 84 includes a number of holes 94 for attachment of the base 84 (on the interior side of door 324) to the exterior assembly 12 (on the exterior side of door 324) a number of fasteners 16, as previously described.

In one or more arrangements, base 84 includes one or more attachment features for connecting a main body 100 of interior assembly 14 to the base 84. Attachment features are formed of any suitable size, shape, and design and are configured to facilitate attachment of main body 100 to the base 84. In the shown arrangement, attachment features are holes 96 on top 88 and holes 96 on bottom 98 of base 84. After base 84 is attached to the interior side of door 324, the main body 100 of interior assembly 14 may be attached to the base 84 by inserting screws or bolts through aligned holes 96 of base and holes 102 of main body 100.

Main Body 100:

In one or more arrangements, interior assembly 14 includes a main body 100. Main body 100 is formed of any suitable size, shape, and design and is configured to facilitate attachment and interconnection connection of components of interior assembly 14. In the arrangement shown, as one example, main body is operably connected to an arrangement of the locking bolts 120, bolt collars 140, center member 158, mechanical assembly 204, and covers 236/248 to form interior assembly 14 with base 84. In the arrangement shown, as one example, main body 100 has an elongated shape extending a length between opposing sides 104. In the example arrangement, main body 100 has a top 106, a bottom 108, a front 110 and a rear 112. In the arrangement shown, as one example, main body 100 has dimensions permitting the rear 112 main body 100 to fit within the opening in front 90 of base 84 in between top 88 and bottom 98 of base 84.

### Guide Tracks 114, 116, and 118:

In the arrangement shown, as one example, main body 100 includes guide tracks 114, 116, and 118 configured to facilitate movement of one or more components of the interior assembly 14 along a length of the main body 100. The guide tracks 114, 116, and 118 are formed of any suitable size, shape, and design and are configured to facilitate operable attachment with and smooth movement of components along the guide tracks 114, 116, and 118.

In an arrangement shown, as one example, guide tracks 114, 116, and 118 are each formed by a respective pair of opposing channels in main body 100. For instance, a first guide track 114 includes a first channel in an upper surface of bottom 108 adjacent to the front 110. In this example arrangement, the guide track 114 also includes a second channel in a bottom surface of top 106 adjacent to the front 110. Slide features 160 of center member 158 are configured to ride within the channels of the guide track 114 and facilitate lateral movement of center member 158 along the guide track 114. In the shown arrangement, as one example, slide features 160 may be inserted within the guide track 114 from one of the sides 104 of the main body 100.

### Locking Bolts 120:

In one or more arrangements, interior assembly 14 includes a set of locking bolts 120 configured to extend from and retract into sides 104 of interior assembly 14 to facilitate locking and unlocking of the interior assembly 14 with end brackets 18. Locking bolts 120 are formed of any suitable size, shape, and design and are configured to facilitate locking and unlocking of the interior assembly 14 with end brackets 18. In the arrangement shown, as one example, locking bolts 120 have an elongated shape with a cylindrical shaped exterior surface 122 extending between opposing ends 124. In the arrangement shown, as one example, locking bolts 120 include a long locking bolt 126 and a short locking bolt 128.

In the arrangement shown, as one example, locking bolt 126 is formed from a first segment 136 similar to short locking bolt 128 and a locking bolt extension 134. Locking bolt extension 134 and segment 136 may be formed of any suitable size, shape, and design and are configured to facilitate connection between segment 136 and bolt extension 134 to form long locking bolt 126. In the arrangement show, as one example, bolt extension 134 includes a smaller diameter end configured to fit inside a recess in an end of segment 136. With end of bolt extension 134 inserted in recess at the end of segment 136, bolt extension 134 and of segment 136 are connected together (e.g. by a locking pin, threading in recess and on end of bolt extension, or any other mechanical attachment).

Locking bolts 120 are formed of any suitable materials known in the art with sufficient strength, rigidity, durability to prevent forced opening of door 324 when system 10 is locked. In one arrangement, for example, locking bolts are formed of a high strength metallic material (e.g., steel), a composite material (e.g., fiberglass, carbon fiber, and the like), or a combination thereof

### Bolt Collars 140:

In one or more arrangements, interior assembly 14 also includes bolt collars 140. Bolt collars 140 are formed of any suitable size, shape, and design and are configured to hold and secure locking bolts 120 with main body 100 while permitting locking bolts to move through bolt collars and extend from and retract into sides 104 of interior assembly 14. In the arrangement shown, as one example, bolt collars 140 have a top 146, a bottom 148, a front 150, a rear 152, and opposing sides 142. In this example arrangement, bolt collars 140 have a cylindrical shaped hollow interior 144 extending between opposing sides 142 of the bolt collars 140. In the arrangement shown, as one example, the cylindrical shaped hollow interior 144 has a diameter approximately equal to that of the locking bolts 120.

In the arrangement shown, as one example, bolt collars 140 are attached to main body 100 near respective opposing sides 104 of main body 100. Long locking bolt 126 extends though hollow interior 144 of a first one or the bolt collars 140 and short locking bolt 128 extends through hollow interior 144 of a second one of the bolt collars 140.

In Operation: In the shown arrangement, as one example, locking bolts 120 are movable between an unlocked position and a fully-extended position. To extend the locking bolts 120, the locking bolts 120 are pushed outward in opposing directions through bolt collars 140. As locking bolts 120 are pushed outward the locking bolts extend outward from sides 86 of interior assembly 14 and engage with end brackets 18 of system 10. In the locked position, locking bolts 120 interlock with end brackets 18 to prevent interior assembly 14 from being moved in a direction toward or away from door 324. To retract the locking bolts 120, the locking bolts 120 are pulled inward through bolt collars 140 to the unlocked position, at which locking bolts 120 to not engage with end brackets 18. In one or more embodiments, for example, in the unlocked position, locking bolts may be nearly flush with sides 86 of the interior assembly 14.

### Center Member 158 and Mechanical Assembly 204:

In one or more arrangements, interior assembly 14 includes a center member 158 and mechanical assembly 204 configured to control extension and retraction of locking bolts 120. In the shown arrangement, as one example, center member 158 is generally configured to move side to side along the length of the interior assembly 14 between an unlocked position and a locked position. In the shown arrangement, as one example, mechanical assembly 204 is operably connected to the center member 158 and locking bolts 120. In this example arrangement, mechanical assembly 204 is generally configured to extend locking bolts 120 outward in opposite directions in response to center member 158 being moved in a direction from the unlocked position to the locked position. In this example arrangement, mechanical assembly 204 is generally configured to retract locking bolts 120 in response to center member 158 being moved in the opposite direction from the locked position to the unlocked position.

### Center Member 158:

Center Member 158 is formed of any suitable size, shape, and design and is configured to facilitate side to side movement of center member 158 along the length of the interior assembly 14. In the arrangement shown, as one example, center member 158 has a front 166, a rear, 164, a top 168, a bottom 170, and opposing sides 162. In the arrangement shown, as one example, center member 158 has a generally elongated shape extending between the opposing sides 162. In this example arrangement, center member 158 has slide features 160 positioned in the rear 164 of center member 158. Slide features 160 of center member 158 are configured to ride within the guide track 114 and facilitate lateral side to side movement of center member 158 along the guide track 114.

### Latch Assembly 192:

In one or more arrangements, the center member 158 includes a latch assembly 192 configure to latch the center member in the locked position and/or the unlocked position of center member 158. Latch assembly 192 is formed of any suitable size, shape, and design and is configured to facilitate latching and release of the center member 158. In the arrangement shown, as one example, latch assembly 192 includes a latch 196 and one or more catches. In one example arrangement, latch 196 is configured to engage a catch(es) when moved to the locked position and/or the unlocked position of center member 158. In one or more arrangements, for example, a catch(es) may be positioned on or form part of main body.

In the arrangement shown, as one example, latch assembly 192 includes a spring 195 configure to spring load the latch 196 to automatically latch when a catch is encountered. In this example arrangement, latch assembly 192 includes a button 194 configured to release the spring latch when button 194 is depressed.

### Cover 182:

In one or more arrangements, the center member 158 includes a cover 182. Cover 182 is formed of any suitable size, shape, and design and is configured to cover components of center member 158 and/or provide an effective handhold for actuation of locking bolts 120, while providing an aesthetically pleasing appearance. In the arrangement shown, as one example, cover 182 has a generally elongated shape extending a length between side edges 186 of cover 182. In this example arrangement, cover 182 has an exterior surface 188 with a generally curved shape extending over the front of center member 158 between top and bottom rear edges 184 of cover 182. In the arrangement shown, as one example, cover 182 has a hole 190 in a bottom surface of the cover 182. In this example arrangement, hole 190 is aligned with and provides user access to button 194 of latch assembly 192.

In different arrangements, cover 182 may be attached to center member 158 using various connection techniques known in the art including, for example, adhesives, epoxies, welding, stapling, crimping, riveting, screwing, bolting, snap-fitting, friction fitting, and/or any other known chemical and mechanical connection techniques. In one or more embodiments, cover 182 is connected to center member 158 by one or more connection members 172. In the arrangement shown, as a particular example, connection members 172 are bolts that extend through holes in cover 182 and center member 158 to connect cover 182 and center member 158 together.

### Mechanical Assembly 204:

In one or more arrangements, interior assembly 14 includes mechanical assembly 204, which is configured to extend locking bolts 120 outward in opposite directions in response to center member 158 being moved in one direction and retract locking bolts 120 in response to center member 158 being moved in the opposite direction. Mechanical Assembly 204 is formed of any suitable size, shape, and design and is configured to facilitate such extension and retraction of locking bolts in response to side to side actuation of center member 158.

In the arrangement shown, as one example, mechanical assembly 204 includes a rack-and-pinion arrangement including a pinion gear 206, a first rack 208 and a second rack 220. First and second racks 208 and 220 are any suitable size, shape, and design and are configured to facilitate smooth movement and engagement with pinion gear 206. In the arrangement shown, as one example, first rack 208 has an elongated rectangular shape extending a length between opposing ends 210 with a set of teeth 212 positioned along the length of one side of the first rack. In this example arrangement, first rack 208 has slide features 216 configured to hold first rack 208 within guide track 116 of main body 100. In this example arrangement, second rack 220 similarly has an elongated rectangular shape extending a length between opposing ends 222 with a set of teeth 224 positioned along the length of one side of the second rack 220. In this example arrangement, second rack 220 has slide features 228 configured to hold second rack 220 within guide track 118 of main body 100.

In the arrangement shown, as one example, pinion gear 206 is operably attached at a fixed axis to main body 100. In this example arrangement, pinion gear 206 is positioned between the first rack 208 and second rack 220 with teeth 212 of first rack 208 engaging one side of pinion gear 206 and teeth 224 of second rack 220 engaging the opposite side of pinion gear 206. In this arrangement, movement of the first rack 208 in one direction causes pinion gear 206 to move the second rack 220 in the opposite direction.

In the arrangement shown, as one example, mechanical assembly 204 includes a connection member 232 configured to operably connect center member 158 to one of the long locking bolt 126. In this example arrangement, mechanical assembly 204 also includes a connection member 218 configured to operably connect center member 158 to the first rack 208. In this example arrangement, mechanical assembly 204 also includes a connection member 230 configured to operably connect second rack 220 to the short locking bolt 128.

### In Operation:

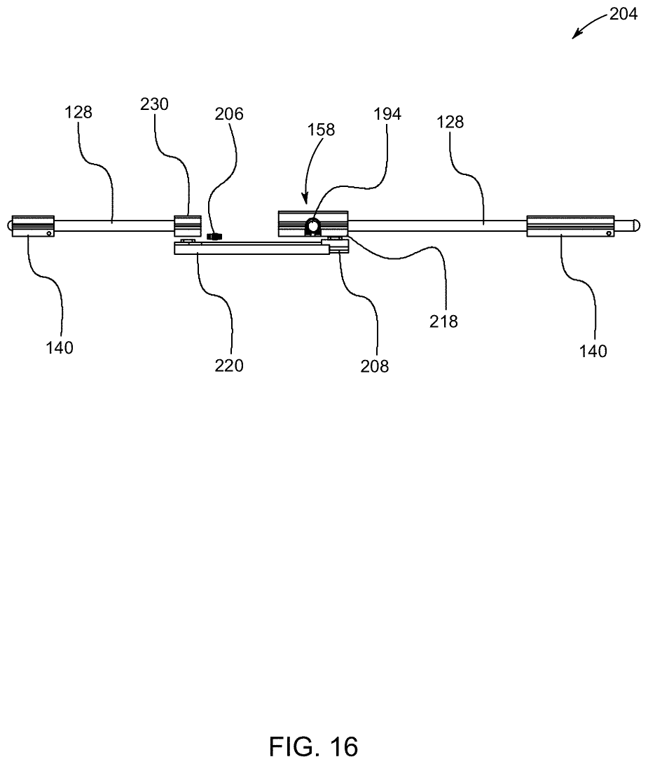

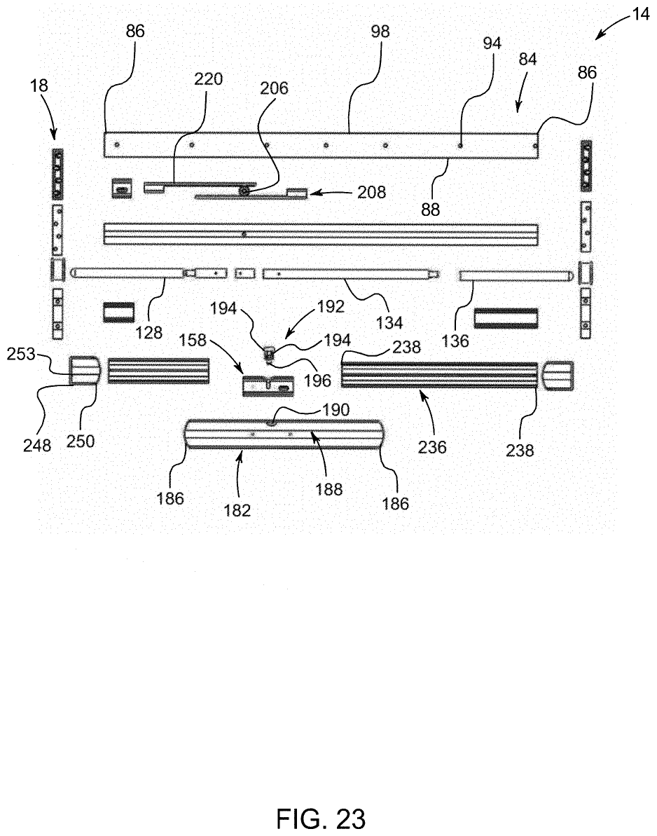

Referring to FIGS. 16 and 23, in the unlocked position, short locking bolt 128 and long locking bolt 126 are each positioned within interior assembly 14 with an end proximate to a side 86 of interior assembly 14. In this position, center member 158 is positioned off-center toward the end of interior assembly with the short locking bolt 128 (e.g., left end of interior assembly).

To lock system 10, center member 158 is moved to the side along the length of interior assembly 14 toward the center. As center member 158 is moved rightward to the center, the operable connection by connection member 232 moves long locking bolt 126 rightward along with center member 158. At the same time, the operable connection provided by connection member 218 moves first rack 208 to the right along with center member 158. Rightward movement of first rack 208 causes counter-clockwise rotation of pinion gear 206, which causes second rack 220 to move to the left. As second rack 220 is moved leftward, the operable connection by connection member 230 moves the short locking bolt 128 to the left.

Rightward movement of the long locking bolt 126 and leftward movement of the short locking bolt 128 cause locking bolts 126 and 128 to extend outward from sides of the interior assembly 14. As locking bolts 126 and 128 approach a locked position, locking bolts engage and interlock with end brackets 18 to lock system 10.

When locked, system 10 structurally reinforces and secures a door against forced entry. Furthermore, as system 10 does not provide a means to unlock system 10 from the exterior side of the door (e.g., using a key), system 10 is not susceptible to being unlocked by an intruder using bump keys or other lock picking techniques. When center member 158, reaches the locked position (near a center of interior assembly 14), latch 196 encounters a catch and is moved into a latched state by spring 195. While in the latched state, latch 196 prevents center member 158 from being moved. This operation helps prevent system 10 from being accidentally unlocked.

To unlock system 10, button 194 is first pressed to unlatch latch 196 and permit movement of center member 158. Center member 158 is then moved leftward to the side. As center member 158 is moved leftward, the operable connection provided by connection member 232 moves long locking bolt 126 leftward along with center member 158. At the same time, the operable connection provided by connection member 218 moves first rack 208 to the left along with center member 158. Leftward movement of first rack 208 causes clockwise rotation of pinion gear 206, which causes second rack 220 to move to the right. As second rack 220 is moved rightward, the operable connection by connection member 230 moves the short locking bolt 128 to the right. Leftward movement of the long locking bolt 126 and rightward movement of the short locking bolt 128 cause locking bolts 126 and 128 to retract back into interior assembly 14. As locking bolts 126 and 128 are retracted locking bolts disengage from end brackets 18 to unlock system 10.

While not described in this illustrative example, in some embodiments, latch 196 is configured to engage a catch and become latched upon reaching an unlocked position. Such arrangement may assist to prevent system from being accidently locked. In such arrangement, a user must press button 194, before moving center member 158 to lock system 10. Body Covers 236 and End

### Covers 248:

In one or more arrangements, in addition to cover 182 of center member 158, interior assembly 14 includes body covers 236 and end covers 248.

### Body Covers 236:

Body covers 236 are formed of any suitable size, shape, and design and are configured to functionally cover components of interior assembly 14, while providing an aesthetically pleasing appearance. In the arrangement shown, as one example, body covers 236 each have a generally elongated shape extending a length between side edges 238 of body cover 236. In this example arrangement, body cover 236 has a generally curved surface defined by front surface 242 and back surface 246. In the arrangement shown, for example, body cover 236 extends between rear edges 240 of body cover 236 and extends over the front of main body 100, mechanical assembly 204, locking bolts 120, and bolt collars 140, among other components of interior assembly 14.

As previously discussed, center member 158 is movable from side to side along a path between an unlocked position and a locked position. In the arrangement shown, as one example, one body cover 236 is positioned on the left side of the path of center member 158 and a second body cover 236 is positioned on the right side of center member 158.

In the arrangement shown, as one example, cover 182 of center member 158 is configured to fit over and in front of body covers 236. Cover 182 extends a length sufficient to cover a side edge 238 of the body cover 236 on the right, when moved to a left most position (e.g., unlocked position), and sufficient to cover a side edges 238 of the body cover 236 on the left when moved to a right most position (e.g., locked position).

In different arrangements, body covers 236 may be attached to main body 100, bolt collars 140, and/or other components of interior assembly 14 using various connection techniques known in the art including, for example, adhesives, epoxies, welding, stapling, crimping, riveting, screwing, bolting, snap-fitting, friction fitting, and/or any other known chemical and mechanical connection techniques. In the arrangement shown, as one example, body covers 236 include connection features 244 configured to engage and interconnect with features 154 of bolt collars 140. More specifically, in the arrangement shown, features 154 of bolt collars 140 are configured to fit channels (connection features 244) positioned on a back surface 246 of body covers 236. In one or more arrangement, body covers 236 may be attached to bolt collars 140 by sliding body covers 236 over bolt collar 140 from the side (e.g., 142).

### End Covers 248:

End covers 248 are formed of any suitable size, shape, and design and are configured to functionally cover sides 104 of interior assembly 14, while providing an aesthetically pleasing appearance.

In the arrangement shown, as one example, end covers 248 have a front surface 254 extending between an exterior side 258 and an inner edge 250. Front surface 254 over ends of interior assembly 14 between top and bottom rear edges 252. In the arrangement shown, exterior side 258 of each end cover 248 has an opening 260. Opening 260 is configured to permit a locking bolt 120 to extend outward from interior assembly 14 though opening 260.

In different arrangements, end covers 248 may be attached to main body 100, base 84, and/or other components of interior assembly 14 using various connection techniques known in the art including, for example, adhesives, epoxies, welding, stapling, crimping, riveting, screwing, bolting, snap-fitting, friction fitting, and/or any other known chemical and mechanical connection techniques. In the arrangement shown, as one example, end covers 248 include holes 256 for attachment of end covers 248 to main body 100 and base 84 with screws.

### End Brackets 18:

In one or more arrangements, system 10 includes end brackets 18. End brackets 18 are formed of any suitable size, shape, and design and are configured to attach to a building on each side 326 of door 324 and engage and interlock with locking bolts 120 when fully-extended, while providing an aesthetically pleasing appearance.

In the arrangement shown, as one example, an end bracket 18 has a front 268, a back 270, a top 262, a bottom 264, and opposing sides 266. In the arrangement shown, as one example, an end bracket 18 also has a cylindrical shaped hole 272 extending though end bracket 18 from a first one of the sides 266 to the opposite side 266. In the arrangement shown, as one example, an end bracket 18 includes the following component pieces: a rear bracket member 274, a front bracket member 294, a collar 310, and a base 334, among other component pieces.

### Rear Bracket Member 274:

Rear bracket member 274 is formed of any suitable size, shape, and design and is configured to facilitate attachment of end bracket 18 to a structure and enclose a rear portion of locking bolt 120 when fully-extended. In the arrangement shown, as one example, rear bracket member 274 has a generally rectangular profile, when viewed from the front, extending between opposing sides 286 and between a top 282 and a bottom 284. In the arrangement shown, as one example, rear bracket member 274 has a generally flat back 280 configured for mounting against a building structure. In the arrangement shown, a front 276 of rear bracket member 274 includes a recess 288 forming a rear portion of the cylindrical shaped hole 272 in the end bracket 18.

In the arrangement shown, as one example, rear bracket member 274 includes a number of holes 290 extending through rear bracket member 274 from front 276 to back 280 to facilitate connection of rear bracket member 274 to a structure (e.g., using screws, bolts, or/and other attachment means).

In the arrangement shown, as one example, rear bracket member 274 includes connection features 292 configured to facilitate attachment with front bracket member 294. In this example arrangement, connection features include threaded recesses configured to receive complementary threaded bolts. However, any mechanical connection of rear bracket member 274 and front bracket member 294 is contemplated.

### Front Bracket Member 294:

Front bracket member 294 is formed of any suitable size, shape, and design and is configured to facilitate attachment with rear bracket member 274 and enclose a front portion of locking bolt 120 when fully-extended. In the arrangement shown, as one example, front bracket member 294 has a generally rectangular profile, when viewed from the front, extending between opposing sides 300 and between a top 296 and a bottom 298. In the arrangement shown, as one example, front bracket member 294 has a front 304 forming front 276 of end bracket 18. In the arrangement shown, as one example, front bracket member 294 has a back 302 configured to mate with and attach to front 276 of rear bracket member 274. In the arrangement shown, as one example, front bracket member 294 includes a recess 306 in the back 302. When front bracket member 294 is attached to rear bracket member 274, recess 306 and recess 288 form an interior surface of cylindrical shaped hole 272 extending between sides 266 of end bracket 18.

In the arrangement shown, as one example, front bracket member 294 includes a number of holes 308 configured to facilitate connection of front bracket member 294 with rear bracket member 274. In this example arrangement, when back 302 of front bracket member 294 is mated with front 276 of rear bracket member 274, holes 302 are aligned with connection features 292. In the arrangement shown, as one example, front bracket member 294 may be connected to rear bracket member 274, using, for example, bolts that extend through hole 302 and thread into complementary threaded recesses of connection features 292.

Front bracket member 294 and rear bracket member 274 are formed of any suitable materials known in the art with sufficient strength, rigidity, durability to prevent forced opening of door 324 when system 10 is locked. In one arrangement, for example, front bracket member 294 and rear bracket member 274 are formed of a high strength metallic material (e.g., steel), a composite material (e.g., fiberglass, carbon fiber, and the like), or a combination thereof.

### Collar 310:

In one or more arrangements, end bracket 18 includes a collar 310 positioned in cylindrical shaped hole 272 and configured to reduce friction and facilitate smooth movement of locking bolts when locking bolts 120 engage with or disengage from end bracket 18.

Collar 310 is formed of any suitable size, shape, and design and is configured to be positioned within cylindrical shaped hole 272 of end bracket 18 and facilitate reception and interlocking with locking bolts 120. In the arrangement shown, as one example, collar 310 has a cylindrical shape with an exterior surface 316 generally extending between opposing ends 312. In the arrangement shown, as one example, exterior surface 316 is configured to mate with the interior surface of cylindrical shaped hole 272 of end bracket 18 when collar 310 is positioned within cylindrical shaped hole 272.

In one or more arrangements, collar 310 also has an opening 314 extending between opposing ends 312 through an interior of collar 310. Opening 314 is formed of any suitable size, shape, and design and is configured to facilitate reception of locking bolts 120 when extended. In the arrangement shown, as one example, opening 314 is generally cylindrical shaped with a diameter approximately equal to an outer diameter of locking bolts 120. While arrangements are primarily described with locking bolts 120 and opening 314 having circular cross sections, embodiments are not so limited. Rather, it is contemplated that locking bolts 120 and opening 314 may have cross section with other shapes (e.g., square, rectangular, oval, and/or any other shape).

In the arrangement show, as one example, the opening 314 is offset from a center of collar 310 when viewed from the side. The offset allows the distance between the opening 314 and back 270 of end bracket 18 to easily be adjusted by rotating collar. Such adjustment capability makes it easier to orient and align opening 314 with locking bolts 120 during installation.

In the arrangement shown, as one example, collar 310 includes flanges 318 configured to ensure collar 310 remained within cylindrical shaped hole 272 after front bracket member 294 is attached to rear bracket member 274. Flanges 318 are formed of any suitable size, shape, and design and are configured to prevent collar from escaping cylindrical shaped hole 272. In the arrangement shown, as one example, flanges 318 extend around each end 312 of collar 310. In this example arrangement, flanges 318 have an outer diameter that is larger than the diameter of cylindrical shaped hole 272.

Collar 310 is formed of any suitable materials known in the art and is configured to facilitate smooth movement of locking bolts when locking bolts 120 engage with or disengage from end bracket 18. With collar 310 positioned within cylindrical shaped hole 272, front bracket member 294 and rear bracket member 274 provide structural support for collar 310. Such structural support provided by front bracket member 294 and rear bracket member 274, permits collar 310 to be formed with lower strength material having self-lubricating characteristics or lower coefficients of friction. In the arrangement shown, as one example, collar 310 is formed of a non-metallic material such as a plastic, a composite, a nylon, a polymer, ultra-high molecular weight polyethylene (UHMW) material, or any other non-metallic material.

In addition to reduced friction, formation of collar 310 with non-metallic material may beneficially reduce manufacturing cost and time. For example, by using a non-metallic collar 310, front bracket member 294 and rear bracket member 274 can be manufactured with a smaller amount of high strength materials, which are typically more expensive. As another example, using non-metallic materials, collar 310 can quickly and cheaply be manufactured with flange 318 (e.g., using a molding process), to keep collar 310 positioned in cylindrical shaped hole 272 without the need to form additional features in front bracket member 294 and rear bracket member 274 which require additional manufacturing steps.

### Base 334:

In one or more arrangements, end bracket 18 includes a base 334. Base 334 is formed of any suitable size, shape, and design and is configured to facilitate attachment of rear bracket member 274 to a wall of a structure when installing end bracket 18. In the arrangement shown, base 334 has a generally rectangular planar shape extending between opposing side edges 336 and between top edge 338 and bottom edge 340. In an arrangement shown, as one example, base 334 has a generally thin cross section between a back surface 344 and a front surface 342, which extend generally parallel to each other.

In one or more arrangements, base 334 includes a number of holes 346 through which rear bracket member 274 may be attached to the wall of a structure. Holes 346 are formed of any suitable size, shape, and design and are configured to facilitate attachment of rear bracket member 274 to structure. In the arrangement shown, as one example, holes 346 in base 334 and holes 290 of rear bracket member are angled to permit fasteners (e.g., screws, bolts, and the like) to be driven into a structure at an angle). Such orientation of fasteners makes is more difficult to pull fasteners out of the structure by force.

Base 334 is formed of any suitable materials known in the art with sufficient strength, rigidity, durability to secure end bracket 18 to a structure and prevent forced opening of door 324 when system 10 is locked. In one arrangement, for example, base 334 is formed of the same or similar material as that used to form front bracket member 294 and rear bracket member 274. In such arrangement, base 334 may be used, for example, to facilitate adjustment of spacing between rear bracket member 274 and a wall of a structure. Alternatively, in some arrangements, base 334 may be formed of a compressible material (e.g., rubber or synthetic polymers) to provide padding to protect a wall of a structure from unnecessary marking or damage by installation of end brackets 18.

### In Operation:

In practice, system 10 can quickly and easily be installed. In an example installation, for illustrative purposes, is first installed by connecting exterior assembly 12 positioned on an exterior side of door 324 with base 84 of interior assembly 14 using fasteners 16 as previously described with reference to fasteners 16.

With exception of base 84 and end covers 248, components of interior assembly 14 can be preassembled. After installation of exterior assembly 12 and base 84, the interior assembly 14 is easily installed by inserting main body 100 of the preassembled portion into front 90 of base 84, by inserting screws or bolts through aligned holes 96 of base and holes 102 of main body 100. After connecting the main body 100 to the base, end covers 248 are installed by attaching of end covers 248 to main body 100 and base 84 with screws through holes 256 of end covers 248.

Following installation of interior assembly 14 and exterior assembly 12, end brackets 18 are installed. In this example installation, locking bolts 120 are first fully-extended via actuation of center member as previously described. With locking bolts 120 fully-extended, a collar 310 may be placed over the locking bolt to facilitate alignment of rear bracket member 274. For instance, an installer may place rear bracket member 274 and base 334 in an approximate desired position on a wall behind collar 310 and rotate the collar 310 until rear bracket member 274 and base 334 are pressed flush against the wall without gaps. This placement of rear bracket member 274 and base 334 may be temporarily marked on the wall for later attachment.

After making placement of rear bracket member 274 and base 334, the rear bracket member 274, base 334, and collar may be set aside and locking bolts 120 may be fully-retracted to make room for installation. Rear bracket member 274 and base 334 are then repositioned at the previously marked position and secured to the wall by driving fasteners through aligned holes 290 and 346 and into the wall. Front bracket member 294 is positioned in front of rear bracket member 274 with collar 310 positioned in cylindrical shaped hole 272. Front bracket member 294 is then secured to rear bracket member 274, for example, using bolts through holes 308 of front bracket member 294. Prior to completely tightening such bolts, collar 310 is rotated until opening 314 is aligned with the locking bolt 120. Bolts through holes 308 of front bracket member 294 are then tightened to complete installation of end bracket 18.

### Vertical Installation:

While the arrangements are primarily shown and described with reference to system 10 being installed horizontally across a door, embodiments are not so limited. Rather, it is contemplated that system 10 may be installed at any orientation to facilitate locking of a door (e.g., horizontally, vertically, and/or diagonally). For example, in some arrangements, system may be installed vertically to secure and lock a door. In such an arrangement, exterior assembly 12, interior assembly 14, and fastener 16 are installed vertically and operate as previously described. An end bracket 18 may be installed above door for engagement with an upper one of the locking bolts 120 when extended as previously described.

A special floor end bracket is installed in the floor to engage with a lower one of the locking bolts 120, when extended. The floor mounted end bracket may be formed of any suitable size, shape, and design and are configured to attach to the floor of an entryway and engage and interlock with locking bolts 120 when fully-extended, while providing an aesthetically pleasing appearance, and providing unobstructed entry and egress through the door when open.

As one illustrative example, in one arrangement, a floor mounted end bracket includes a generally planar rectangular plate having a set of holes for attachment to the floor (e.g., with screws and/or bolts). The floor mounted end bracket further also includes an opening. The opening of the floor mounted end bracket is formed of any suitable size, shape, and design and is configured to facilitate reception of a lower one of locking bolts 120 when extended. In one example arrangement, opening of the floor mounted end bracket is generally cylindrical shaped with a diameter approximately equal to an outer diameter of locking bolts 120. While arrangements are primarily described with locking bolts 120 and opening of the floor mounted end bracket having circular cross sections, embodiments are not so limited. Rather, it is contemplated that locking bolts 120 and opening of the floor mounted end bracket may have cross section with other shapes (e.g., square, rectangular, oval, and/or any other shape).

In one or more arrangements the floor mounted end bracket includes a collar positioned within the opening of the floor mounted end bracket. Such collar of the floor mounted end bracket is formed of any suitable size, shape, and design and is configured to facilitate reception of a lower one of locking bolts 120 when extended, while facilitating smooth extension and retraction of locking bolts 120. In an example arrangement, collar is positioned within the opening of the floor mounted end bracket and includes a recess configured to receive the lower one of the locking bolts 120 when extended.

In one or more arrangements, collar of floor mounted end bracket is formed with a material having self-lubricating characteristics or lower coefficients of friction such as a plastic, a composite, a nylon, a polymer, ultra-high molecular weight polyethylene (UHMW) material, or any other non-metallic material. The disclosed components of system 10 may be formed of any suitable materials known in the art with sufficient strength, rigidity, durability, and frictional characteristics to maintain correct operation of system 10 when large positive or negative forces are applied to door 324, while providing an aesthetically pleasing appearance. Such materials may include but are not limited to, for example metallic materials (e.g., steel, aluminum, as well as other metal and/or alloys thereof), composite material (e.g., fiberglass, carbon fiber, and the like), non-metallic materials (e.g., plastic, a nylon, a polymer, ultra-high molecular weight polyethylene (UHMW) material, or any other non-metallic material) and/or a combination thereof.

From the above discussion it will be appreciated that system 10 presented herein improves upon the state of the art. It will be appreciated by those skilled in the art that other various modifications could be made to the device without parting from the spirit and scope of this disclosure. All such modifications and changes fall within the scope of the claims and are intended to be covered thereby.

What is claimed:

1. A door lock system, comprising:
first and second end brackets, each of the first and second end brackets having a front, a back, a top, a bottom and opposing sides;
an interior assembly, the interior assembly having an elongated shape extending a length between opposing sides of the interior assembly;
wherein the interior assembly includes a main body, the main body having an elongated shape extending a length between opposing sides;
wherein the interior assembly includes a first locking bolt; the first locking bolt having an elongated shape extending between opposing ends;
wherein the interior assembly includes a second locking bolt; the first locking bolt having an elongated shape extending between opposing ends;
wherein the interior assembly includes a center member, the center member being configured and arranged to move along the length of the main body between a first position and a second position;
a mechanical assembly; the mechanical assembly operably attached the first and second locking bolts and the center member;
wherein the mechanical assembly is configured and arranged to extend the first and second locking bolts outward from the opposing sides of interior assembly to a locked position in response to the center member being moved from the first position to the second position;
wherein the mechanical assembly is configured and arranged to retract the first and second locking bolts inward into the main body to unlocked position in response to the center member being moved from the second position to the first position; and
wherein the first and second end brackets are each configured and arranged to receive an end of one of the first and second locking bolts in the locked position.

2. The system of claim 1, wherein:
the interior assembly includes a base; the base being configured and arranged for attachment to an interior side of the door;
the interior assembly includes a main body; the main body being configured and arranged for attachment to the base;
the mechanical assembly includes an operable connection between the first locking bolt and the center member;
the mechanical assembly includes a rack and pinion assembly operably connected to the center member;
wherein the rack and pinion assembly is operably connected to the second locking bolt;
wherein response to the center member being moved in a first direction, the rack and pinion assembly moves the second locking bolt in a second direction opposite from the first direction; and
the operable connection between the first locking bolt and the center member configured to move the first locking bolt in the first direction in response to the center member being moved in the first direction.

3. The system of claim 1, wherein:
the mechanical assembly includes an operable connection between the first locking bolt and the center member;
the mechanical assembly includes a rack and pinion assembly operably connected to the center member;
the rack and pinion assembly includes a pinion gear operably attached to the main body in a fixed axis of rotation;
the rack and pinion assembly includes a first rack operably attached to the center member;
the rack and pinion assembly includes a second rack operably attached to the second locking bolt; and
the first and second racks are operably connected to the pinion gear in a configuration that movement of the first rack in a first direction causes the pinion gear to move the second rack in a second direction that is opposite of the first direction.

4. The system of claim 1, wherein:
the mechanical assembly includes an operable connection between the first locking bolt and the center member;
the mechanical assembly includes a rack and pinion assembly operably connected to the center member;
the rack and pinion assembly includes a pinion gear operably attached to the main body in a fixed axis of rotation;
the rack and pinion assembly includes a first rack operably attached to the center member;
the rack and pinion assembly includes a second rack operably attached to the second locking bolt;
the main body includes one or more guide tracks;
the first and second racks include slide features configured to engage the one or more guide tracks and facilitate movement of the first and second racks along the one or more guide tracks;
the center member includes slide features configured to engage the one or more guide tracks and facilitate movement of the center along the one or more guide tracks.

5. The system of claim 1, further comprising:
an exterior assembly;
wherein the exterior assembly is configured and arranged for attachment to an exterior side of a door;
wherein the exterior assembly has an elongated shape extending a length between opposing ends; and
a fastener configured to attach the interior assembly to the exterior assembly through one or more holes in the door.

6. The system of claim 1, further comprising:
an exterior assembly;
wherein the exterior assembly is configured and arranged for attachment to an exterior side of a door;
wherein the exterior assembly has an elongated shape extending a length between opposing ends; and
a fastener configured to attach the interior assembly to the exterior assembly through one or more holes in the door;
wherein: the fastener is configured and arranged, when tightened, to compress the door between the interior assembly and the exterior assembly.

7. The system of claim 1, further comprising:
an exterior assembly;
the exterior assembly having a base, a main body, and a cover.

8. The system of claim 1, wherein:
the interior assembly further includes first and second bolt collars attached to the main body;
the first bolt collar is configured to hold and secure the first locking bolt with the main body while permitting locking bolts to move through the first bolt collar; and
the second bolt collar is configured to hold and secure the second locking bolt with the main body while permitting locking bolts to move through the second bolt.

9. The system of claim 1, wherein:
the interior assembly includes a cover;
the cover has an elongated shape extending a length between side edges of the cover; and
the cover extends has an exterior surface with a curved shape extending over a front of the center member between a top rear edge of cover and a bottom rear edge of the cover.

10. The system of claim 1, wherein:
the interior assembly includes a first end cover configured to cover a first one of the sides of the main body;
the interior assembly includes a second end cover configured to cover a second one of the sides of the main body;
wherein the first end cover has side with a first opening;
wherein the first locking bolt is configured to extend through the first opening in the locked position;
wherein the second end cover has side with a second opening; and
wherein the second locking bolt is configured to extend through the second opening in the locked position.

11. The system of claim 1, wherein:
the center member includes a latch assembly;
wherein the latch assembly includes a button;
the latch assembly is configured to latch the center member in place in response to the center member being moved to the second position; and
the latch assembly is configured to unlatch in response to the button being pressed.

12. The system of claim 1, wherein:
the center member includes a latch assembly;
wherein the latch assembly includes a button;
the latch assembly is configured to latch the center member in place in response to the center member being moved to the first position; and
the latch assembly is configured to unlatch in response to the button being pressed.

13. The system of claim 1, wherein:
wherein the first end bracket has a cylindrical shaped hole extending through the first end bracket between the opposing sides of the first end bracket;
the first end bracket includes a rear bracket member;
the first end bracket includes a front bracket member; and
the cylindrical shaped hole is positioned between the rear bracket member and the front bracket member.

14. The system of claim 1, wherein:
wherein the first end bracket has a cylindrical shaped hole extending through the first end bracket between the opposing sides of the first end bracket;
the first end bracket includes a collar positioned in the cylindrical shaped hole;
the collar extending between opposing ends;
the collar includes a first flange extending around the a first one of the opposing ends of the collar;
the collar includes a second flange extending around the a second one of the opposing ends of the collar;
the collar is a non-metallic material.

15. A door lock system, comprising:
an interior assembly, the interior assembly being configured and arranged for attachment to an interior side of the door;
wherein the interior assembly has an elongated shape extending a length between opposing ends of the interior assembly;
an exterior assembly, the exterior assembly being configured and arranged for attachment in an exterior side of the door;
wherein the exterior assembly has an elongated shape extending a length between opposing ends of the exterior assembly;
a fastener configured to attach the interior assembly to the exterior assembly through one or more holes in the door;
first and second end brackets;
wherein the interior assembly includes first and second locking bolts;
wherein the interior assembly includes a center member;
wherein the center member is configured and arranged for side to side movement along the length of the interior assembly between a first position and a second position;
wherein the interior assembly includes a mechanical assembly configured and arranged to extend the first and second locking bolts outward from the ends of the interior assembly in opposing directions to a locked position in response to the center member being moved from the first position to the second position;
wherein the mechanical assembly is configured and arranged to retract the first and second locking bolts inward into the interior assembly to an unlocked position in response the center member being moved from the second position to the first position; and
wherein the first and second end brackets are each configured and arranged to receive an end of one of the first and second locking bolts in the locked position.

16. The system of claim 15, wherein: the fastener is configured and arranged, when tightened, to compress the door between the interior assembly and the exterior assembly.

17. The system of claim 15, wherein:
the exterior assembly includes a base, the base having a front surface and a rear surface; and
the base has an elongated shape extending between a top edge, a bottom edge, and opposing side edges of the base of the exterior assembly.

18. The system of claim 15, wherein:
the exterior assembly includes a main body;
the main body has an elongated shape extending between opposing sides of the main body;
the main body has a front, a rear, a top and a bottom;
the main body includes a plurality of holes extending through the rear of the main body;
the main body includes a recess extending along the length of the main body;
a nut is positioned in the recess;
the recess is configured to receive and prevent rotation of the nut; and
a bolt is inserted through one of the plurality of holes and is threaded through the nut.

19. The system of claim 15, wherein:
the mechanical assembly includes a rack and pinion assembly operably connected to the center member;
wherein the rack and pinion assembly is operably connected to the second locking bolt;
wherein, in response to the center member being moved in a first direction, the rack and pinion assembly moves the second locking bolt in a second direction opposite from the first direction;
the operable connection between the first locking bolt and the center member configured to move the first locking bolt in the first direction in response to the center member being moved in the first direction;
the rack and pinion assembly includes a pinion gear operably attached to the main body in a fixed axis of rotation;
the rack and pinion assembly includes a first rack operably attached to the center member;
the rack and pinion assembly includes a second rack operably attached to the second locking bolt; and
the first and second racks are operably connected to the pinion gear in a configuration that movement of the first rack in the first direction causes the pinion gear to move the second rack in the second direction.

20. A door lock system, comprising:
first and second end brackets, each of the first and second end brackets having a front, a back, a top, a bottom and opposing sides;
an interior assembly, the interior assembly having an elongated shape extending a length between opposing sides of the interior assembly;
wherein the interior assembly includes a main body, the main body having an elongated shape extending a length between opposing sides;
wherein the interior assembly includes a first locking bolt; the first locking bolt having an elongated shape extending between opposing ends;
wherein the interior assembly includes a second locking bolt; the first locking bolt having an elongated shape extending between opposing ends;
wherein the interior assembly includes a center member, the center member being configured and arranged to move along the length of the main body between a first position and a second position;
a mechanical assembly;
the mechanical assembly configured to extend and retract first and second locking bolts;
wherein the first end bracket has a cylindrical shaped hole extending through the first end bracket between the opposing sides of the first end bracket;
the first end bracket includes a collar positioned in the cylindrical shaped hole;
the collar extending between opposing ends;
the collar having an offset hole extending between the opposing ends of the collar;
wherein the offset hole is configured to receive an end of one of the first and second locking bolts in the locked position;
wherein the collar is rotatable to facilitate alignment of the offset hole with the one of the first and second locking bolts.
